(19) United States
(12) Patent Application Publication
(10) Pub. No.: US 2023/0378714 A1
(43) Pub. Date: Nov. 23, 2023

(54) Q-SWITCH CO2 LASER

(71) Applicant: Alltec Angewandte Laserlicht Technologie GmbH, Selmsdorf (DE)

(72) Inventors: Daniel J Ryan, Sycamore, IL (US); Ryan R Ahern, Glen Ellyn, IL (US)

(21) Appl. No.: 18/257,689

(22) PCT Filed: Dec. 20, 2021
(86) PCT No.: PCT/EP2021/086779

§ 371 Date: Jun. 15, 2023

(30) Foreign Application Priority Data
Dec. 21, 2020 (GB) 2020241.2

(51) Int. Cl. H01S 3/223; H01S 3/115; H01S 3/08; H01S 3/105

(52) U.S. Cl. CPC H01S 3/2232; H01S 3/115; H01S 3/08059; H01S 3/105

(57) ABSTRACT

A CO₂ laser configured to produce infrared electromagnetic radiation comprising an optical element comprising a frequency selective structure having a substantially periodic pattern of features. A frequency response of the optical element is configured to change upon receipt of a signal. A Q-factor of the CO₂ laser changes upon receipt of the signal. A laser marking system may incorporate the CO₂ laser.

### TECHNICAL FIELD

Aspects and implementations of the present disclosure are directed generally towards a tunable optical element comprising a frequency selective structure having a periodic pattern of features. A frequency response of the tunable optical element is controllable and is configured to change upon receipt of a signal. The tunable optical element may be incorporated into a variety of optical devices to at least partially control the optical devices. For example, the tunable optical element could be incorporated as a mirror or an output coupler of a laser, e.g. a carbon dioxide (CO₂) laser. The tunable optical element may be used to Q-switch the laser upon receipt of the signal.

### BACKGROUND

Lasers are used in various industrial production lines to perform operations on workpieces by, for example, etching, engraving, machining, cutting, and/or welding.

Laser marking systems may be utilized to imprint markings, for example, images, identification numbers, expiration dates, and/or bar codes on the surfaces of various products. The marking of a material may be affected by ablation (i.e. removal of material), a color change, or by a change in a surface texture of the material. Marking by all of these processes occurs when temperature of the material illuminated by the laser beam exceeds the threshold for the physical process to be affected. The physical properties of the material determine the threshold temperature. The critical material properties are absorptivity at the wavelength of the laser illumination, thermal diffusivity, and thermal conductivity. Thus, for every material there is a unique value for the laser energy density (which may be represented by the units J/mm²) required to reach the threshold temperature to affect the desired marking process. The laser energy density required to mark a particular material at least partially determines the required laser type (e.g. a CO₂ laser) and beam parameters (e.g. spot size, power, etc.). The laser energy density may be understood as a peak power of the laser multiplied by a laser on-time (i.e. a time during which the laser beam is incident on the material) divided by an area of the material that the laser beam illuminates (i.e. (P*t)/(spot size)). An optical design of the laser determines the spot size. The spot size may comprise a diameter of about 50 μm or more. The spot size may comprise a diameter of about 700 μm or less.

An energy or power applied by the laser to the material over time is at least partially determined by the application (e.g. the material to be marked, the time available for marking the material, the complexity of the mark, etc.). For example, typical paper-based packaging material may be marked using a low-power (e.g. 10-30 Watt), continuous wave laser. As another example, metals generally require high peak power (e.g. about 1 kW or more) lasers with short on-times (e.g. about 1 μs or less) to overcome the relatively rapid heat dissipation of metals and retain the desired mark contrast. As a further example, some plastics such as HDPE require high peak power to reach the temperature necessary for readable marking.

It may be impractical to produce a laser beam with the amount of power needed to affect a desired alteration to a metal workpiece with a laser operating in a continuous wave (constant output) mode. Some lasers utilizing a technique known as Q-switching can be made to produce a pulsed output beam including light pulses with peak powers much higher than would be produced by the same laser operating in a continuous wave mode.

Whilst Q-switches are generally known, there remains a need for compact, relatively inexpensive Q-switches that can be manufactured on a large scale for lasers operating in certain ranges of wavelengths (e.g. infrared wavelengths).

### SUMMARY

According to a first aspect of the present disclosure, there is provided an optical element comprising a frequency selective structure having a substantially periodic pattern of features, wherein a frequency response of the optical element is configured to change upon receipt of a signal.

The optical element advantageously allows a user to control a frequency response of an optical system comprising the optical element. For example, the optical element may be used to Q-switch a laser by changing its frequency response to reflect, transmit and/or absorb more or less electromagnetic radiation within a given range of frequencies. The optical element advantageously enables a compact Q-switching system having a lower form factor than known Q-switches. The optical element advantageously has an improved energy efficiency compared to known Q-switches. The optical element is cheaper to manufacture than known Q switches.

A substantially periodic pattern of features may have a periodicity that varies by less than about 10%. A substantially periodic pattern of features may be referred to as a periodic pattern of features.

The signal may be generated by a controller. The signal may comprise thermal, electrical, and/or optical energy. The signal may comprise an applied electromagnetic field. The signal may comprise electromagnetic radiation. The signal may comprise an applied voltage or bias.

The frequency selective structure may act as a band pass optical filter or a band reject optical filter for a range of frequencies of incident electromagnetic radiation. The band pass or band reject action of the frequency selective structure, and/or the optical element as a whole, may change upon receipt of the signal such that a range of frequencies of electromagnetic radiation that was previously passed is now rejected, or vice versa. In some embodiments, the frequency selective structure may comprise a frequency selective surface.

A reflectivity, a transmissivity and/or an absorptivity of the optical element may change across a range of frequencies of electromagnetic radiation upon receipt of the signal.

Changing the reflectivity, transmissivity and/or absorptivity of the optical element on command may allow the optical element to act as a Q-switch in a laser. For example, the reflectivity of the optical element could be set to a first relatively low value (e.g. less than about 50%) and induce a relatively large loss in a lasing cavity of the laser.

Changing the reflectivity to a second relatively high value (e.g. about 99%) for a short period based on a pulse width of the laser (e.g. about 100 μs or less) may reduce the loss in the lasing cavity and allow lasing to occur, thereby Q-switching the laser. The second value may be an optimum value. The optimum value may depend on the type of laser being used, the desired properties of the pulses generated by the laser, the use of the pulses that are generated by the laser, etc.

The range of frequencies of electromagnetic radiation may comprise infrared radiation. Infrared lasers, such as CO₂ lasers, have a variety of uses, such as marking products on a production line. Some materials, such as some plastics, may require relatively high power pulses of infrared radiation in order to be marked. The optical element may be used to Q-switch an infrared laser, and thereby advantageously enable the marking of a greater number of materials. The optical element may be configured to have a controllable frequency response for infrared radiation. The optical element may be configured to have a controllable frequency response for wavelengths of about 8 μm or more. The optical element may be configured to have a controllable frequency response for wavelengths of about 15 μm or less. The optical element may be configured to have a controllable frequency response for one or more wavelength bands centering on about 9.3 μm, about 9.6 μm, about 10.2 μm, and about 10.6 μm.

The optical element of the present disclosure may be used to Q-switch other types of lasers, such as ultraviolet (UV) lasers and/or visible light lasers.

The optical element may comprise a switching component operably coupled to the frequency selective structure.

The switching component may take the form of a layer on the optical element. The switching component may at least partially surround the periodic pattern of features of the frequency selective structure. The frequency selective structure may be embedded in, or otherwise surrounded by, the switching layer. The switching component may be bonded to the frequency selective structure. For example, the frequency selective structure may comprise a periodic pattern of features provided (e.g. etched or disposed) on an active switching layer. The periodic pattern of features may comprise a metal.

The switching component may comprise a semimetal (e.g. graphene). The switching component may comprise a semiconductor having an adjustable value of charge carrier density (e.g. GaAs). The switching component may comprise a liquid crystal (e.g. E7, a liquid crystal offered by Merck KGaA, a company based in Darmstadt, Germany). The switching component may comprise a phase change material (e.g. vanadium dioxide).

The optical element may comprise a signal transmission component operably coupled to the switching component configured to receive the signal and transmit the signal to the switching component.

The signal transmission component may comprise indium tin oxide, a patterned metal such as gold, patterned silicon, gallium arsenide and/or another semiconductor material.

The optical element may comprise a deformable material configured to change a periodicity and/or a geometry of the periodic pattern of features upon receipt of the signal.

The deformable material may form part of an actuator configured to respond to the signal.

The signal may generate or change an electric and/or magnetic field configured to cause deformation of the deformable material.

The deformable material may be a resilient material. This advantageously reduces the energy required to reverse a change to the frequency response of the optical element because the resilient material will return to its original state upon the removal of a force acting on it.

The deformable material may be formed from a broad class of materials where the properties of stress, strain, and/or elasticity are used to change the shape of the material upon the application of a stimulus via thermal, mechanical and/or electrical means.

Suitable deformable materials may include piezoelectric materials, shape-memory metals (e.g. Ni—Ti alloy), shape-memory polymers, rubber, etc.

The geometry of the periodic pattern of features may comprise the shape, size and relative arrangement of the periodic pattern of features.

A refractive index of the optical element may be configured to change upon receipt of the signal.

An electric permittivity and/or a magnetic permeability of the optical element may be configured to change upon receipt of the signal.

A conductivity and a resistivity of the optical element may be configured to change upon receipt of the signal.

The periodic pattern of features may comprise an array of geometric features configured to at least partially determine the frequency response of the optical element.

The frequency response of the optical element may at least partially depend upon a periodicity and/or geometry of the periodic pattern of features. For example, the features may comprise slots, dipoles, crosses, rings, split rings, etc. Complimentary features may produce complimentary effects on the frequency response of the optical element. For example, the slots may act as a pass band filter by increasing the transmission of a range of wavelengths of radiation, whereas the dipoles may act as a reject band filter by decreasing the transmission of a range of wavelengths of radiation. The frequency selective structure may comprise a grid array of slots, dipoles, crosses, rings, split rings and/or any other geometric feature.

A periodicity and/or geometry of the periodic pattern of features may be selected in at least dependence on a wavelength of light that will be incident upon the optical element.

In the case of infrared electromagnetic radiation generated by a CO₂ laser, the features may, for example, have a periodicity of about 1 μm or more. In the case of infrared electromagnetic radiation generated by a CO₂ laser, the features may, for example, have a periodicity of about 10 μm or less. In the case of infrared electromagnetic radiation generated by a CO₂ laser, the features may, for example, have a width and/or length of about 0.3 μm or more. In the case of infrared electromagnetic radiation generated by a CO₂ laser, the features may, for example, have a width and/or length of about 3 μm or less.

Some features such as, for example, split-ring resonators may reduce the range of wavelengths of electromagnetic radiation that are within the frequency response of the optical element. This may advantageously provide a highly targeted frequency response. That is, a narrow pass or reject band that only requires a relatively low energy signal to adjust.

The features may be made from a material (e.g. a metal) on a substrate using an additive process and/or complementary features may be made using a reductive process (i.e. by removing material). For example, a slot and a dipole may be considered as being complementary features. The periodic pattern of features could be fabricated either way (i.e. additive and/or reductive processes). The features may be fabricated using imprint technology, e.g. nano-imprint technology, using a master mould.

The array may comprise tuning elements configured to at least partially determine the frequency response of the optical element.

The tuning elements may comprise one or more geometric features (e.g. bars) that are configured to alter a geometry of the frequency selective structure to adjust the frequency response of the optical element.

The periodic pattern of features may be configured to act as a polarizer.

The frequency selective structure may be polarization sensitive or insensitive depending on the geometry of the periodic surface features. This offers a different way of controlling the laser via polarization dependent effects. Having a polarization sensitive frequency selective structure may be particularly advantageous for certain applications (e.g. CO₂ lasers) because the radiation generated by the laser is polarized.

The optical element may comprise a metamaterial.

The metamaterial may form part of the frequency selective structure. The metamaterial may comprise a metal and a dielectric. The metamaterial may be a plasmonic metamaterial. That is, the metamaterial may have plasmonic resonance characteristics.

The metamaterial may be configured to respond to infrared wavelengths of electromagnetic radiation. A metamaterial-based laser Q-switch can be created by designing the physical geometry of the array of features composing the metamaterial and, at the same time, selecting the materials surrounding these geometric features based on desired switchable electromagnetic properties. The metamaterial may comprise, for example, a frequency selective structure comprising graphene formed on a base of ZnSe.

The optical element may comprise a semiconductor. A charge carrier density of the semiconductor may be configured to change upon receipt of the signal.

The semiconductor may comprise Si, GaAs, Ge, InP, GaAlAs and/or many others. The optical and electrical properties of semiconductors may be controlled by doping through the introduction of impurities in the lattice structure of the material. Using lithography and deposition technology, patterns and features can be created on substrates to perform a variety of functions. A monolithic Q-switch can be fabricated by incorporating the frequency selective structure and switching component into a single device. An advantage of using a semiconductor based design is that a metal-free structure can be fabricated having low-loss and high efficiency. Changing the charge carrier density of the semiconductor may change a refractive index of the frequency selective structure, thereby changing a transmissivity, reflectivity and/or absorptivity of the optical element.

The optical element may comprise a phase change material configured to change phase upon receipt of the signal.

The term “phase change material” covers a broad range of compounds that undergo a physical change when exposed to an external stimulus. Phase change materials are used in a wide variety of applications such as random access memory devices, CDs and DVDs, and smart windows. The chalcogenide glass used in random access memory devices changes between amorphous and crystalline states. During such a transition, the resistivity may be caused to change on a microscopic level in response to an electrical stimulus. The chalcogenide glass, GeSbTe, is used in CDs where an optical stimulus is used to change between amorphous and crystalline states to change the reflectivity of the surface. Smart windows use the insulator-to-metal phase transition of sesquioxide (V₂O₃) to change the reflectivity with temperature. The phase change material may be configured to change between being amorphous and being crystalline, or vice versa, upon receipt of the signal. The phase change material may be configured to change between being in an insulating phase and being in a metallic phase, vice versa, upon receipt of the signal. Changing the phase of the phase change material may change a conductivity and resistivity of the frequency selective structure, thereby changing a transmissivity, reflectivity and/or absorptivity of the optical element.

The phase change material may comprise VO₂.

Vanadium dioxide (VO₂) may be a preferred phase change material for implementing a CO₂ laser Q-Switch. The insulator-to-metal phase transition of VO₂ can be stimulated by thermal, electrical, or optical means. It has been shown that the insulator-to-metal phase transition can be stimulated by electrical or optical sources in the sub-microsecond time regime. Thus, an optical element comprising a frequency selective structure and an active layer of VO₂ would be sufficient to rapidly change the frequency response of optical element and thereby Q-switch the laser.

The optical element may comprise a liquid crystal. An optical property of the liquid crystal may be configured to change upon receipt of the signal.

Liquid crystals are a family of materials that, under the right conditions of temperature and/or concentration, exhibit liquid and crystalline properties simultaneously. The optical properties of liquid crystals vary depending on the materials of the liquid crystal. A common characteristic of liquid crystals is a change in birefringence with the application of a potential difference. The signal may comprise the application of voltage across the optical element comprising the liquid crystal that may change the birefringence behaviour of the liquid crystal, thereby changing the polarization characteristics and/or the refractive index of the liquid crystal. This is turn may change a transmissivity, reflectivity and/or absorptivity of the optical element. Variation in the optical properties of the liquid crystal due to the applied bias may change the transmissivity, reflectivity and/or absorptivity of the frequency selective structure. Such an optical element may be used to Q-switch a laser, e.g. a CO₂ laser. The liquid crystal may comprise E7.

The optical element may comprise graphene. An electric permittivity of the graphene may be configured to change upon receipt of the signal.

Graphene is a single atomic layer of carbon whose electric permittivity may be changed by the application of an electrical bias. An optical element for Q-switching a laser may comprise the frequency selective structure, a graphene layer, and a means for biasing the graphene, e.g. a metal contact. Alternatively, the graphene may be lithographically processed to incorporate the periodic pattern of features of the frequency selective structure. The biasing of the graphene may cause a change in the electric permittivity of the optical element, thereby changing a transmissivity, reflectivity and/or absorptivity of the optical element.

The frequency selective structure may comprise a plurality of frequency selective layers configured to at least partially determine the frequency response of the optical element.

Having a plurality of frequency selective layers advantageously allows the frequency response of the optical element to be fine-tuned, thereby providing an optical element having a sharper frequency response and/or a multi-frequency response. For example, a first layer of the plurality of frequency selective layers may be configured to have a desired interaction with (e.g. reflect, absorb or transmit) radiation having a wavelength of about 10.2 μm whereas another layer may be configured to have a desired interaction with radiation having a wavelength of about 10.6 μm.

According to a second aspect of the present disclosure, there is provided a laser comprising the optical element of the first aspect.

The laser may be suitable for material treatment of a target. The material treatment may comprise one or more of marking the target, engraving the target, cutting the target, etc.

The laser may comprise a resonant cavity comprising two mirrors that define an optical path through a gain medium. One of the mirrors may be a substantially totally reflecting mirror (e.g. a “rear mirror” or a “fold mirror”) and the other mirror may be a partially reflecting mirror for outputting the pulses of radiation (i.e. an “output coupler”).

The optical element may be a reflector, e.g. a mirror. The reflector may be “highly reflective” (e.g. having a reflectivity of 95% or more, e.g. about 99%).

The laser may comprise a controller configured to provide the signal to the optical component, e.g. to Q switch the laser.

A Q-factor of the laser may change upon receipt of the signal.

The optical element may comprise a first state in which a Q factor of the laser has a first value and a second state in which the Q factor of the laser has a different value. Laser Q-switching may be implemented by providing the signal to the optical element to switch the optical element between the first state and the second state. The switching component may be configured to change the controllable optical property between the first state and the second state upon receipt of the signal.

The band pass or band reject action of the optical element may be relatively narrow such that a small change caused by the signal induces a relatively large change of the frequency response of the optical element.

The geometry of the frequency selective structure (e.g. the periodicity of the features) and the electromagnetic properties (e.g. the refractive index, permittivity, permeability, conductivity, resistivity, etc.) of the surrounding materials (e.g. the switching component) may determine the frequency response of the optical element. For example, increasing a conductivity of the switching component may reduce a reflectivity of the optical element, which may lead to an optical cavity of the laser comprising the optical element becoming more lossy, thereby decreasing a Q factor of the laser. The frequency response of the frequency selective structure may be selected based on a range of operating wavelengths of the laser.

The optical element may form part of a rear mirror of the laser.

The periodic pattern of features may be designed such that the frequency selective structure acts as a band pass filter at the operating wavelength of the laser. This would induce a high loss in the cavity and inhibit lasing. When the signal changes the frequency response of the optical element, the frequency selective structure may act as a regular rear mirror with very low radiative losses, thereby allowing stimulated emission and lasing to occur.

The optical element may form part of an output coupler of the laser.

The reflectivity of an output coupler may be selected to optimize an output power of the laser while minimizing radiative losses in the lasing cavity. The optimum reflectivity of the output coupler is heavily dependent on the laser design. However, once optimized, the reflectivity of the output coupler typically remains fixed. Incorporating the optical element into the laser as the output coupler allows the reflectivity of the output coupler to be changed on command to Q-switch the laser.

The optical element may form part of a fold mirror of the laser.

The signal may change the frequency response of the optical element across an operating range of wavelengths of the laser from being highly reflective, to be being highly transmissive or absorptive, and vice versa. When in a highly reflecting state, the resonant cavity may experience relatively low losses of photons (i.e. a high Q factor).

When in a highly transmissive or absorptive state, the resonant cavity may experience relatively high losses of photons (i.e. a low Q factor).

The optical element may form part of a passive optical component of the laser.

When the optical element is incorporated into the laser as a passive optical component the signal may change the frequency response of the optical element from being highly transmissive (causing a low loss state in the resonant cavity, i.e. a high Q factor), to being partially transmissive or absorptive (causing a high loss state in the resonant cavity, i.e. a low Q factor).

According to a third aspect of the present disclosure, there is provided a laser marking system for marking a target comprising the laser of the second aspect.

According to a fourth aspect of the present disclosure, there is provided a method of marking a target with radiation comprising using the laser marking system of the third aspect.

According to a fifth aspect of the present disclosure, there is provided a method of Q-switching a laser to generate pulses of radiation comprising providing the laser with the optical element of the first aspect and using a controller to provide the signal to the optical element to Q-switch the laser.

According to a sixth aspect of the present disclosure, there is provided a CO₂ laser configured to produce infrared electromagnetic radiation. The CO₂ laser comprises an optical element comprising a frequency selective structure having a substantially periodic pattern of features. A frequency response of the optical element is configured to change upon receipt of a signal. A Q-factor of the CO₂ laser changes upon receipt of the signal.

The CO₂ laser may be configured to produce infrared electromagnetic radiation having an average power of about 10 W. The CO₂ laser may be configured to produce infrared electromagnetic radiation having an average power of about 30 W. The CO₂ laser may be configured to produce infrared electromagnetic radiation having an average power of about 50 W. The CO₂ laser may be configured to produce infrared electromagnetic radiation having an average power of about 100 W.

The CO₂ laser may comprise a laser cavity comprising a CO₂ gain medium. The CO₂ laser may comprise a radio frequency excitation source configured to excite the CO₂ gain medium to produce infrared electromagnetic radiation.

The RF excitation source may be configured to provide RF power of about 150 W or more. The RF excitation source may be configured to provide RF power of about 1 kW or less. The RF excitation source may be configured to provide RF power at a frequency of about 80 MHz or more. The RF excitation source may be configured to provide RF power at a frequency of about 120 MHz or less. The RF excitation source may be configured to provide RF power at a frequency of about 100 MHz or more. The RF excitation source may be configured to provide RF power to the CO₂ gain medium for a duration of about 0.1 μsec or more. The RF excitation source may be configured to provide RF power to the CO₂ gain medium for a duration of about 1.0 μsec or less. The RF excitation source may be configured to provide RF power to the CO₂ gain medium continuously. A pulse duration of the RF excitation source may be controlled by user of the CO₂ laser. A pulse duration of the RF excitation source may be at least partially dependent on one or more of the desired laser pulse energy for marking a product, a pulse repetition frequency or a product rate, and an average power of the CO₂ laser.

The CO₂ laser may comprise a control system configured to provide the signal to the optical element to Q-switch the CO₂ laser. The control system may be configured to provide a separate control signal to the radio frequency excitation source to excite the CO₂ gain medium.

The optical element may form part of a rear mirror of the CO₂ laser.

The CO₂ laser may comprise a folded cavity having a fold mirror. The optical element may form part of the fold mirror of the CO₂ laser.

The optical element may comprises silicon or GaAs. These reflective base materials are compatible with the CO₂ laser plasma present in the CO₂ laser. A complex index of refraction (n+jk) of the silicon at a wavelength of about 10.6 μm may be about (3.4179+j0.0001223). A complex index of refraction (n+jk) of the GaAs at a wavelength of about 10.6 μm may be about (3.2646+j0.00029).

The optical element may form part of an output coupler of the CO₂ laser.

The optical element may form part of a passive optical component located in a laser cavity of the CO₂ laser.

The optical element may comprises ZnSe, GaAs, Ge or ZnS. These transmissive base materials are compatible with the CO₂ laser plasma present in the CO₂ laser. A complex index of refraction (n+jk) of the ZnSe at a wavelength of about 10.6 μm may be about (2.4028). A complex index of refraction (n+jk) of the GaAs at a wavelength of about 10.6 μm may be about (3.2646+j0.00029). A complex index of refraction (n+jk) of the Ge at a wavelength of about 10.6 μm may be about (4.0038). A complex index of refraction (n+jk) of the ZnS at a wavelength of about 10.6 μm may be about (2.1925+j0.002).

The optical element may comprise graphene. An electric permittivity of the graphene may be configured to change upon receipt of the signal. A complex index of refraction (n+jk) of the graphene at a wavelength of about 10.6 μm may change between about (4.45−j4.34) and about (14.43−j0.08) upon receipt of the signal.

The optical element may comprise a phase change material configured to change phase upon receipt of the signal.

The phase change material may comprise VO₂. A complex index of refraction (n+jk) of the VO₂ at a wavelength of about 10.6 μm may change between about (2.1+j0.16) in an insulating state to about (7.8+j 5.8) in a metallic state upon receipt of the signal.

The optical element may comprise a semiconductor. A charge carrier density of the semiconductor may be configured to change upon receipt of the signal. The semiconductor may form part of a photoconductive device. The photoconductive device may be configured to receive an optical signal (e.g. a laser pulse) to Q-switch the CO₂ laser.

The semiconductor may comprise at least one of GaAs, Si, or Ge.

The optical element may comprise a liquid crystal. An optical property of the liquid crystal may be configured to change upon receipt of the signal.

The signal may comprise a bias voltage. The bias voltage may be greater than 0 V. The bias voltage may be less than or equal to about 20 V. The bias voltage may be applied for about 1 ns or more. The bias voltage may be applied for about 100 μs or less. The bias voltage may be applied for about 150 ns or less. A duration for which the bias voltage is applied may be selected in at least partial dependence on a desired laser pulse energy to be produced by the CO₂ laser. The desired laser pulse energy to be produced by the CO₂ laser may depend on an application of the CO₂ laser (e.g. medical applications or industrial applications).

The signal may comprise a laser pulse. The laser pulse may be produced by a short-pulsed laser diode. The short-pulsed laser diode pulse may have a pulse width of 1 nsec or more. The short-pulsed laser diode pulse may have a pulse width of 100 μsec or less.

A reflectivity, a transmissivity and/or an absorptivity of the optical element may change across a range of frequencies of infrared electromagnetic radiation upon receipt of the signal.

The optical element may comprise a switching component operably coupled to the frequency selective structure.

The optical element may comprise a signal transmission component operably coupled to the switching component configured to receive the signal and transmit the signal to the switching component. The signal transmission component may comprise a layer of conductive material. The layer of conductive material may comprise at least one of gold, nickel, aluminium, and indium tin oxide (ITO). The optical element may comprise an insulating material. The insulating material may comprise one or more of aluminium oxide and hafnium oxide.

The optical element may comprise a deformable material configured to change a periodicity and/or a geometry of the substantially periodic pattern of features upon receipt of the signal.

A refractive index of the optical element may be configured to change upon receipt of the signal.

An electric permittivity and/or a magnetic permeability of the optical element may be configured to change upon receipt of the signal.

A conductivity and a resistivity of the optical element may be configured to change upon receipt of the signal.

The substantially periodic pattern of features may comprise an array of geometric features configured to at least partially determine the frequency response of the optical element.

The array may comprise tuning elements configured to at least partially determine the frequency response of the optical element.

The substantially periodic pattern of features may be configured to act as a polarizer.

The optical element may comprise a metamaterial.

The frequency selective structure may comprise a plurality of frequency selective layers configured to at least partially determine the frequency response of the optical element.

The infrared electromagnetic radiation may be configured to mark a product.

The CO₂ laser may be configured to produce short-pulsed infrared electromagnetic radiation. The CO₂ laser may be configured to produce a short pulse (pulse width >0.1 nsec and <500 μsec) of infrared electromagnetic radiation.

The signal may be configured to control a bias level of a switching component of the optical element. The signal may be configured to control a timing between a laser output command of the CO₂ laser and an initiation of Q-switching of the CO₂ laser.

The infrared electromagnetic radiation may form part of an industrial process. The CO₂ laser may form part of an industrial system. For example, the CO₂ laser and infrared electromagnetic radiation generated by the CO₂ laser may be used in laser marking and coding, engraving, drilling, cutting, drilling, welding (metals and plastics), surface treatment (laser peening, hardening, polishing, roughening, blackening), rust removal, paint removal, etc.

The infrared electromagnetic radiation may form part of a medical process. The CO₂ laser may form part of a medical system. For example, the CO₂ laser and infrared electromagnetic radiation generated by the CO₂ laser may be used as a laser scalpel, in otolaryngology and head and neck surgical procedures, in gynaecologic surgery, in lesion and tumour removal, in vascular surgery, in oral soft tissue surgery, in enamel ablation, in implant dentistry, in tattoo removal, in laser-evoked nociceptive potentials for migraine treatment, in burn scar treatment, in skin resurfacing, in birthmark removal, in mole and viral wart removal, in skin aging, in removal of facial scaring, etc.

According to a seventh aspect of the present disclosure, there is provided a laser marking system for marking a target comprising the CO₂ laser of the sixth aspect.

According to an eighth aspect of the present disclosure, there is provided a method of Q-switching a CO₂ laser to produce infrared electromagnetic radiation comprising exciting a CO₂ gain medium of the CO₂ laser. The method comprises generating a signal to change a frequency response of a frequency selective structure having a substantially periodic pattern of features on an optical element of the CO₂ laser and thereby produce a pulse of infrared electromagnetic radiation.

Generating the signal may comprise operating a controller to produce an electric signal or an optical signal (e.g. a laser pulse).

The infrared electromagnetic radiation may be configured to mark a product.

The method may comprise producing short-pulsed infrared electromagnetic radiation.

The CO₂ laser may be configured to produce a short pulse (pulse width >0.1 nsec and <500 μsec) of infrared electromagnetic radiation.

According to a ninth aspect of the present disclosure, there is provided a method of marking a target with infrared electromagnetic radiation comprising exciting a CO₂ gain medium of the CO₂ laser. The method comprises generating a signal to Q-switch the CO₂ laser by changing a frequency response of a frequency selective structure having a substantially periodic pattern of features on an optical element of a CO₂ laser, thereby producing a pulse of infrared electromagnetic radiation. The method comprises directing the pulse of infrared electromagnetic radiation to the target.

Generating the signal may comprise operating a controller to produce an electric signal or an optical signal (e.g. a laser pulse).

The method may comprise producing short-pulsed infrared electromagnetic radiation.

The CO₂ laser may be configured to produce a short pulse (pulse width >0.1 nsec and <500 μsec) of infrared electromagnetic radiation.

It will be appreciated that the example signal durations (e.g. RF power signal, Q-switch signal (e. the bias voltage signal), etc.) described above are for CO₂ laser marking applications, and that durations outside of those provided above are also possible depending on the application requirements of the CO₂ laser.

It will be appreciated that the example materials described above are suitable for CO₂ lasers but should not preclude the use of other materials. For example, metal mirrors could be used as a base material for an optical element according to the present disclosure.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labelled in every drawing. In the drawings:

FIG. 1 is a schematic plan view of an embodiment of a laser comprising a tunable optical element according to an aspect of the present disclosure.

FIG. 2 illustrates a tunable optical element comprising a frequency selective structure having a periodic pattern of features according to an aspect of the present disclosure.

FIG. 3 illustrates a tunable optical element comprising a frequency selective structure having a periodic pattern of features and a switching component operably coupled to the periodic pattern of features according to an aspect of the present disclosure.

FIG. 4 illustrates an exploded view of the tunable optical element of FIG. 3.

FIG. 5 illustrates an exploded view of a tunable optical element comprising a frequency selective structure, a switching component and a signal transmission component configured to receive the signal and transmit the signal to the switching component according to an aspect of the present disclosure.

FIG. 6A illustrates a tunable optical element comprising a frequency selective structure comprising an array of geometric features, a switching component comprising a phase change material comprising VO₂ on a ZnSe substrate according to an aspect of the present disclosure.

FIGS. 6B and 6C illustrates the optical transmission and reflection frequency response of the tunable optical element of FIG. 6A in an insulating phase and a metallic phase after receipt of a signal.

FIG. 7A illustrates a tunable optical element comprising a frequency selective structure, a switching component comprising graphene, and a ZnSe substrate according to an aspect of the present disclosure.

FIGS. 7B and 7C illustrates the optical transmission and reflection frequency response of the tunable optical element of FIG. 7A with different applied chemical potentials.

FIG. 8A illustrates the optical transmission frequency response of a tunable optical element comprising a frequency selective structure, and a switching component comprising the liquid crystal E7 on a ZnSe substrate in biased and unbiased states according to an aspect of the present disclosure.

FIG. 8B illustrates the optical reflection frequency response of a tunable optical element of FIG. 8A in the biased and unbiased states.

FIG. 9A illustrates the optical transmission frequency response of a tunable optical element comprising a frequency selective structure, a switching component comprising a semiconductor comprising GaAs for a range of charge carrier densities according to an aspect of the present disclosure.

FIG. 9B illustrates the optical reflection frequency response of the tunable optical element of FIG. 9A for the range of charge carrier densities.

FIG. 10 schematically depicts a perspective view from above a portion of a frequency selective structure comprising a periodic pattern of slots according to an aspect of the present disclosure.

FIG. 11 schematically depicts a perspective view from above a portion of a frequency selective structure comprising a periodic pattern of crosses according to an aspect of the present disclosure.

FIG. 12 schematically depicts a perspective view from above a portion of a frequency selective structure comprising a periodic pattern of rings according to an aspect of the present disclosure.

FIG. 13 schematically depicts a perspective view from above a portion of a frequency selective structure comprising a periodic pattern of split rings according to an aspect of the present disclosure.

FIG. 14 schematically depicts a perspective view from the side of a CO₂ laser according to an aspect of the present disclosure.

FIG. 15 schematically depicts a cross-sectional view of an output coupler of the CO₂ laser of FIG. 14.

FIG. 16 schematically depicts a cross-sectional view of a rear mirror of the CO₂ laser of FIG. 14.

FIG. 17 schematically depicts a perspective view of a CO₂ laser comprising a folded cavity according to an aspect of the present disclosure.

FIG. 18 schematically depicts a cross-sectional view of two of the fold mirrors and the output coupler of the CO₂ laser of FIG. 17.

FIG. 19 schematically depicts a cross-sectional view of two of the fold mirrors and the output coupler of the CO₂ laser of FIG. 17, further comprising a passive optical component according to an aspect of the present disclosure.

FIG. 20 schematically depicts a laser marking system comprising a CO₂ laser according to an aspect of the present disclosure.

FIG. 21 shows a flowchart of a method of Q-switching a CO₂ laser to produce infrared electromagnetic radiation according to an aspect of the present disclosure.

FIG. 22 shows a method of marking a target with infrared electromagnetic radiation according to an aspect of the present disclosure.

### DETAILED DESCRIPTION

Aspects and embodiments disclosed herein are capable of being practiced or of being carried out in various ways and are not limited to the details of construction and the arrangement of components set forth in the following description or illustrated in the drawings.

Aspects and embodiments disclosed herein include an optical element comprising a frequency selective structure having a substantially periodic pattern of features. The substantially periodic pattern of features may be referred to as a periodic pattern of features. It will be understood, however, that strict periodicity is not required. The periodicity of the pattern of features may vary by about 10% or less. The optical element may be described as being a tunable optical element because a frequency response of the optical element is controllable. That is, the optical element's effect on incident electromagnetic radiation may be controlled or tuned to have different effects on different wavelengths at different times. For example, the optical element may be tuned to be highly transmissive for a first wavelength at a first time and highly reflective for the first wavelength at another time after the receipt of a signal. The frequency response of the tunable optical element is configured to change upon receipt of a signal. Aspects and embodiments disclosed herein also include a laser comprising the tunable optical element for use in a variety of implementations such as, for example, a laser marking system.

Laser marking systems may be utilized in production lines for marking various types of targets or articles. For example, laser marking systems may be utilized to imprint bar codes, unique identifying marks, expiration dates, or other information on items passing through a production line. Visible and near infrared Q-switch lasers are commonly used for marking in laser marking systems. The present invention advantageously enables a reduction of size and cost of said visible and near-IR Q-switch lasers. The present invention also advantageously enables the use of a carbon dioxide (CO₂) Q-switched laser for laser marking applications. The optical element of the present disclosure may be used to Q-switch other types of lasers, such as ultraviolet (UV) lasers and/or visible light lasers. CO₂ lasers typically produce beams of infrared electromagnetic radiation in four principal wavelength bands centering on 9.3, 9.6, 10.2, and 10.6 micrometers (μm).

For marking certain materials exhibiting a higher marking threshold (e.g. metals) a higher peak laser output power may be desired. In various aspects and embodiments disclosed herein, a CO₂ laser comprising a tunable optical element for Q-switching the laser may be utilized to produce the relatively high peak laser power levels that may be desired for marking workpieces comprising materials exhibiting a relatively high thermal conductivity. Embodiments of the laser systems disclosed herein are not limited to use in laser scanning or marking systems, but may be utilized in any of multiple industrial or commercial implementations. Embodiments of the tunable optical element for Q-switching the laser may be utilized in any other laser technology or wavelength by appropriately scaling the periodic features and/or by the choice of materials used.

In general, a laser comprises two mirrors and a gain medium. The two mirrors are arranged to create a resonant cavity with a gain medium present between the two mirrors. The quality-factor (Q-factor) of a laser's resonant cavity is a measure of its ability to sustain lasing action. The Q-factor of a laser is proportional to the ratio of the energy stored in the resonant cavity (i.e. the energy pumped into the gain medium) to the loss of energy in one round-trip oscillation of electromagnetic radiation through the resonant cavity (i.e. the loss of photons within the resonant cavity). A high Q-factor is required to initiate and sustain lasing in a resonant cavity of a laser. The lower the Q-factor, the higher the loss of photons in the resonant cavity and the harder it is to initiate and sustain lasing action through stimulated emission of radiation. The energy stored in the resonant cavity is at least partially determined by the gain medium and the ability to efficiently pump energy into the gain medium using an external source such as, for example, direct electric current (DC) or radio frequency (RF) power. The loss of photons in the resonator may at least partially be determined by, for example, the reflectivity of the mirrors, diffraction losses, interaction of the photons with the walls of the resonant cavity, and absorptive losses within the resonant cavity. For lasing to occur, and for the laser to have a high Q-factor, the lifetime of a photon circulating in the resonant cavity should be much longer than the time taken for the photon to travel the round-trip length of the resonant cavity.

Q-switching of a laser may be accomplished by controlling a loss mechanism in such a way that the Q-factor of the resonant cavity of the laser can be switched from a high value to a low value and vice-versa. By doing so, a short laser pulse can be generated with high peak power instead of a continuous wave output having a lower peak power.

Q-switching may be achieved by disposing a variable attenuator or other form of switchable (i.e. controllable) photon loss mechanism inside the resonant cavity of a laser.

When the loss mechanism is in a lossy state (i.e. when the loss mechanism causes the loss of photons in the resonant cavity), the Q-factor of the laser may be reduced to a level at which lasing cannot begin. The variable attenuator or loss mechanism may be referred to as a Q-switch. Although a variable attenuator may be utilized as a Q-switch in some embodiments, various mechanisms that can be used to control the Q-factor of the resonant cavity of a laser or to control the production or output of electromagnetic radiation from the resonant cavity of a laser may be utilized as a Q-switch.

To produce a high power laser pulse utilizing Q-switching, energy is pumped into the resonant cavity of a laser while the Q-switch is set to cause the resonant cavity of a laser to exhibit a low Q-factor such that lasing is not initiated. Energy introduced into the gain medium of a laser causes atoms and/or molecules in the gain medium to transition from a ground state to an excited state, resulting in a population inversion in the gain medium.

The energy stored in the resonant cavity increases with continued pumping of energy into the gain medium, but lasing does not begin due to the low Q-factor of the resonant cavity (i.e. photons in the resonant cavity are lost before they can instigate significant amounts of stimulated emission of radiation from the gain medium). After a certain time the energy stored in the resonant cavity may reach a maximum level (a state that may be referred to as “gain saturation”) that may be at least partially be determined by factors such as the amount of energy pumped into the gain medium and losses from spontaneous emission of photons from the pumped gain medium. After the resonator is gain saturated (or in some embodiments before full gain saturation is achieved) the state of the Q-switch may be changed or switched to increase the Q-factor of the resonant cavity, thereby allowing lasing (i.e. significant amounts of stimulated emission of radiation from the gain medium) to begin. The intensity of laser light in the resonant cavity builds quickly due to the large amount of energy stored in the gain medium. The radiation may be quickly released from the resonant cavity, resulting in a short pulse (in some embodiments, on the order of nanoseconds or less) of high intensity laser radiation. The short pulse of high intensity laser radiation may have a peak power of thousands of times or more of the power of laser radiation produced when the laser operates in continuous wave mode.

Q-switching is used in some solid-state laser and fibre laser technologies to generate short pulses (femtoseconds to nanoseconds in duration) and high peak powers (megawatts to gigawatts) for various applications in materials processing. The mechanisms used in Q-switching such lasers may include electro-optic crystals, acousto-optic crystals, and saturable absorbers.

Even though there is a demonstrated advantage to using short-pulsed lasers for materials processing, no viable Q-switched CO₂ laser product exists on the market. The existing technology solutions are cost prohibitive, increase the size of the laser to an unmanageable degree (e.g. the laser is too large to be used in production lines) and/or suffer performance limitations (e.g. Q-switch inefficiency, pulse frequency, and lifetime).

Aspects and embodiments of the invention disclosed herein include tunable optical elements and methods for Q-switching a laser that are inexpensive, manufacturable in a compact size, and actively driven but consume minimal power relative to known Q-switches.

Embodiments of a tunable optical element that may act as a Q-switch device in a laser disclosed herein are switchable between lossy and less lossy states, e.g. between transmissive and reflective states, via an external control signal. Embodiments of the tunable optical element disclosed herein may form part of an output coupler, a rear mirror, a fold mirror, or a passive optical component in the resonant cavity of a laser.

Embodiments of the tunable optical element comprise a frequency selective structure having a periodic pattern of features. In some embodiments, the frequency selective structure may comprise a frequency selective surface. The frequency selective structure may comprise a metamaterial (e.g. a metasurface) having plasmonic resonance characteristics. Embodiments of the tunable optical element may further include a switching component in communication with the periodic pattern of features for changing a controllable optical property (e.g. the reflectivity, transmissivity and/or absorbance characteristics) of the tunable optical element. In this way, the tunable optical element may be used to control the loss of photons in the resonant cavity of a laser and the Q-factor of the resonant cavity. Q-switching the resonant cavity may be achieved by providing a signal to the switching component to change the frequency response of the tunable optical element (e.g. a reflectivity, a transmissivity and/or an absorptivity of the tunable optical element changes for a range of frequencies of electromagnetic radiation) on command. The tunable optical element may form part of a CO₂ laser and the range of frequencies of electromagnetic radiation may comprise infrared radiation (e.g. wavelengths between about 8 μm and about 15 μm).

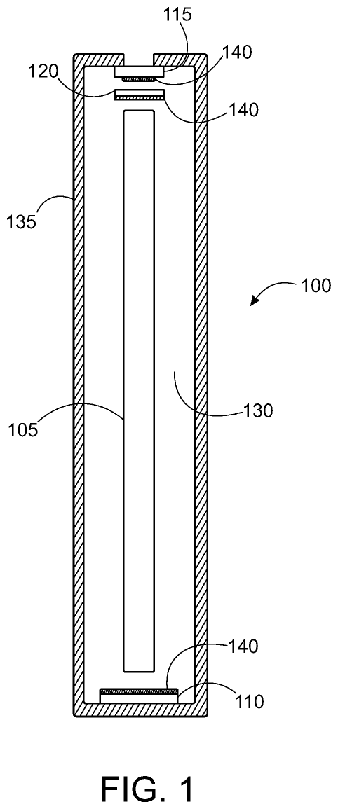

The invention may be applied to any laser technology and, in particular, to any CO₂ laser technology. Any optical element in a DC-excited laser, RF-excited waveguide laser, slab laser, or free-space laser may be converted into a tunable optical element for Q-switching the laser. One example of a waveguide configured laser comprising a tunable optical element at least partially functioning as a Q-switch device is illustrated schematically in FIG. 1. The laser 100 includes a tube 105 which defines a gain region, a fully reflective rear mirror 110 and a partially reflective output coupler 115 which defines the resonant cavity of the laser 100. The resonant cavity may comprise fold mirrors (not shown) to extend the length of the cavity. It is noted that although element 105 is illustrated and described herein as a tube acting as a waveguide, in other embodiments this element 105 may include conduits with alternative cross sections, such as oval, square, or rectangular cross-sections. In still other embodiments, the gain region may be constrained by metal plates that also act as electrodes such as in a slab laser configuration.

When operating in continuous wave mode, electromagnetic energy, for example, radio frequency (RF) energy is applied to the tube 105 to excite a gain medium (e.g. a gas mixture) within the tube 105. The RF energy may have a frequency of about 27 MHz or more. The RF energy may have a frequency of about 120 MHz or less. The RF energy may have a frequency of about 95 MHz. The gas mixture may, for example, comprise He:N₂:CO₂. In some example embodiments the output coupler 115 may be configured to reflect about the photons travelling out of the tube 105 back into the tube 105 and may allow the remaining photons to pass out of the laser 100 as a laser beam (not shown).

The output coupler 115 may be configured to reflect about 45% or more of incident photons. The output coupler 115 may be configured to reflect about 95% or less of incident photons. The output coupler may be configured to reflect about 80% of incident photons. A Q-switch laser may comprise an output coupler 115 having a lower reflectivity than that of a continuous wave laser.

In some embodiments, the rear mirror 110 may be a silicon mirror that may be coated with silver, gold, or any other highly reflective material (e.g. having a reflectivity of about 97% or more at the selected wavelength of operation). The rear mirror 110 may exhibit a reflectivity of about 99.8% for photons generated in the laser. Fold mirrors, when used, may be formed from the same materials as the rear mirror 110 and have substantially the same reflectivity as the rear mirror 110. The output coupler 115 may be formed of a material such as zinc selenide or another material and coated with a desired material selected to be partially reflective to photons at the particular wavelength of photons generated in the laser 100, or to a particular wavelength of interest in instances of lasers generating photons with multiple wavelengths. The waveguide tube 105 may be formed of a dielectric material such as, for example, aluminium oxide (Al₂O₃, alumina), and may be substantially pure, for example, alumina with a purity of 99.9% or more so that there are few impurities present that may interfere with the purity of the gain medium in the laser 100. The gaseous mixture in the laser 100 may comprise a mix of, for example, 5% xenon, 57% helium, 19% nitrogen, and 19% CO₂, although other gas mixtures known in the art may alternatively be used. The gas mixture may fill an entirety of an internal volume 130 of the laser 100 and the tube 105 may be open at its ends to allow the gas mixture to circulate though the tube 105 and an internal volume 130 of the body 135 of the laser 100. The tube 105 may have an outer diameter of about five mm and an inner diameter of about three mm in a waveguide configuration, or may be larger in a free-space configuration.

The laser 100 may further include a tunable optical element 140 comprising a frequency selective structure having a periodic pattern of features that forms part of any of the optical components of the laser 100. Q-switching of the laser 100 may involve changing a frequency response of the tunable optical element 140 for an operating bandwidth of the laser 100. Disclosed herein are four example implementations of incorporating a tunable optical element 140 comprising a frequency selective structure as part of an optical component of a laser for Q-switching the laser 100. The first example implementation includes incorporating the tunable optical element 140 as part of the rear mirror 110. The rear mirror 110 is normally a high reflectivity surface (e.g. having a reflectivity of about 97% or more, e.g. about 99.5%) which makes a relatively small contribution to the loss of photons within the resonant cavity of the laser 100. When the tunable optical element 140 forms part of the rear mirror 110 (e.g. replacing a fixed highly reflecting coating), the rear mirror 110 is switchable between a highly reflective state and a more transmissive and/or absorptive state for a range of wavelengths of electromagnetic radiation corresponding to an operating bandwidth of the laser. By changing the frequency response of the rear mirror 110 in this way, it is possible to change the extent of losses of photons in the resonant cavity, and thereby Q-switch the laser 100 to produce powerful pulses of radiation.

The second example implementation includes incorporating the tunable optical element 140 as part of the output coupler 115 (e.g. replacing a fixed partially reflecting coating).

Normally, the reflectivity of the output coupler 115 is designed to achieve a desired output power of the laser 100 while at the same time reducing the loss of photons in the resonant cavity. An optimum reflectivity of the output coupler 115 is dependent on the laser design. In known lasers, once the reflectivity of the output coupler 115 has been optimized it remains fixed. Incorporating the tunable optical element 140 as part of the output coupler 115 allows the frequency response (e.g. the reflectivity) of the output coupler 115 to be changed upon receipt of a signal (i.e. on command). The reflectivity of the output coupler 115 could be set to a very low value and induce a large loss of photons in the resonant cavity. Changing the reflectivity of the output coupler 115 back to the optimum value for a short period would reduce the loss of photons in the resonant cavity and allow lasing to occur, thereby Q-switching the laser 100 to produce powerful pulses of radiation.

The third example implementation includes incorporating the tunable optical element as part of a fold mirror in a folded cavity laser (not shown). The tunable optical element may have a first state in which a frequency response of the fold mirror is highly reflective to reduce photon losses in the resonant cavity and allow lasing to occur. The tunable optical element may have a second state in which the frequency response of the fold mirror is highly transmissive and/or absorptive to increase photon losses in the resonant cavity and prevent lasing from occurring. By providing a signal to switch the tunable optical element between the first and second states, the laser may be Q-switched to produce powerful pulses of radiation.

The fourth example implementation includes incorporating the tunable optical element 140 as part of a passive optical component 120 within the path of radiation in the laser 100. For example, the passive optical component may be disposed between the tube 105 and the output coupler 115. Other implementations may have the passive optical component 120 located in front of the rear mirror 110, or a fold mirror (not shown), or any other suitable location in the laser beam path. The tunable optical element 140 may have a first state in which a frequency response of the tunable optical element 140 is highly transmissive to reduce photon losses in the resonant cavity and allow lasing to occur. The tunable optical element 140 may have a second state in which the frequency response of the tunable optical element 140 is highly absorptive to increase photon losses in the resonant cavity and prevent lasing from occurring. By providing a signal to switch the tunable optical element 140 between the first and second states, the laser may be Q-switched to produce powerful pulses of radiation.

Embodiments of the tunable optical element 140 comprising the frequency selective structure may be thought of as having a capacitive or inductive nature. That is, the tunable optical element 140 and frequency selective structure may be configured to act as a band pass optical filter or band reject optical filter respectively for a range of wavelengths of incident electromagnetic radiation. The band pass or band reject action of the frequency selective structure, and the tunable optical element 140 as a whole, may change upon receipt of a signal such that a range of frequencies of electromagnetic radiation that was previously passed is now rejected, or vice versa.

The periodic pattern of features of the frequency selective structure may comprise an array of simple features such as a slot and/or dipole array. Alternatively or additionally, the periodic pattern of features of the frequency selective structure may comprise an array of more complicated features such as an array of rings or split-ring-resonators. For example, the slots may act as band pass optical filters by transmitting a range of wavelengths of radiation more than other wavelengths of radiation. The wavelengths passed by the slots may correspond to a geometry of the slots. As another example, the dipoles may act as a band reject optical filter by absorbing a range of wavelengths of radiation more than other wavelengths of radiation. The wavelengths absorbed by the dipoles may correspond to a geometry of the dipoles.

Split-ring resonators may reduce the range of wavelengths of electromagnetic radiation that are within the band pass or band reject function of the optical element. This may advantageously provide a highly targeted frequency response for a narrow range of wavelengths. A relatively small change in the geometry and/or electromagnetic properties of the tunable optical element 140 (e.g. using a relatively low energy signal) may then result in a relatively large change in the frequency response (e.g. the reflectivity, transmissivity and/or absorptivity) of the tunable optical element. Any array of features may additionally comprise tuning elements configured to at least partially determine the frequency response of the tunable optical element 140. The tuning elements may comprise one or more geometric features (e.g. bars) that are configured to alter a geometry of the frequency selective structure to adjust the frequency response of the tunable optical element 140.

The periodic pattern of features of the frequency selective structure of the optical element 140 may be configured to act as a polarizer. That is, the periodic pattern of features may be polarization sensitive or polarization insensitive depending on the geometry of the pattern of features. The geometry of the frequency selective structure (e.g. the periodicity of the periodic pattern of features) and the electromagnetic properties (e.g. the refractive index, electric permittivity, magnetic permeability, conductivity, resistivity, etc.) of any combined components (e.g. a switching component) may at least partially determine the frequency response of the optical element 140.

The frequency selective structure may comprise a plurality of frequency selective layers configured to at least partially determine the frequency response of the optical element 140. Having a plurality of frequency selective layers advantageously allows the frequency response of the tunable optical element 140 to be further fine-tuned, thereby providing a tunable optical element having a sharper frequency response and/or a multi-frequency response. For example, a first layer of the plurality of frequency selective layers may be configured to have a desired interaction with (e.g. reflect, absorb or transmit) radiation having a wavelength of about 10.2 μm whereas another layer may be configured to have a desired interaction with radiation having a wavelength of about 10.6 μm.

To act as a Q-switch in a laser 100, the frequency response of the tunable optical element 140, and the way in which the frequency response changes upon receipt of the signal, may be tailored to the operating wavelengths of the laser. The frequency response may be tailored by designing the physical geometry of the periodic pattern of features that form the frequency selective structure and/or by selecting the materials operably coupled to (e.g. in contact with and/or surrounding) the periodic pattern of features on the basis of desired switchable optical and electromagnetic properties. For example, the tunable optical element 140 may comprise a switching component operably coupled to the frequency selective structure. The switching component may take the form of a layer on the tunable optical element. The switching component may at least partially surround the periodic pattern of features of the frequency selective structure. The frequency selective structure may be embedded in, or otherwise surrounded by, the switching component. The switching component may be bonded to the frequency selective structure. For example, the frequency selective structure may comprise a periodic pattern of features provided (e.g. etched or disposed) on an active switching layer. The periodic pattern of features may comprise a metal. The switching component may comprise a material whose electromagnetic properties are alterable, e.g. a phase change material such as vanadium dioxide.

A rear mirror 110 comprising an optical element 140 having a frequency selective structure may have its periodic pattern of features designed such that in one state of the switching component the tunable optical element 140 acts as a band pass optical filter at the operating wavelengths of the laser 100. This would induce a relatively high loss of photons in the resonant cavity and thereby inhibit lasing. When the switching component is changed to the other state upon receipt of the signal, the tunable optical element 140 acts as a highly reflective mirror causing a reduced loss of photons in the resonant cavity and allows lasing to occur. This switching could be induced by changing one or more of the physical properties of the frequency selective structure and/or the switching component. Switching the tunable optical element 140 (i.e. changing the frequency response of the optical element) may be accomplished by, for example, altering the charge carrier density of a part of the tunable optical element (e.g. the switching component) such as in a photoconductor or semiconductor material. Other approaches include changing the phase of a material (e.g. from amorphous to crystalline or from insulating to metallic), using deformable material to change a periodicity and/or a geometry of the periodic pattern of features, changing the index of refraction and/or the electric permittivity and/or the magnetic permeability of a material, etc. These changes may be enacted by applying an electric and/or magnetic field, injecting a current, biasing with a voltage, or applying optical energy to the tunable optical element 140.

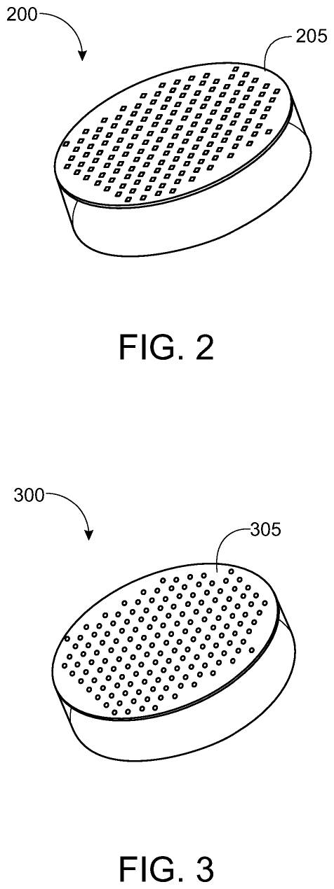

Possible implementations of a tunable optical element comprising a frequency selective structure that may act as a Q-switch in a laser are schematically illustrated in FIGS. 2-5.

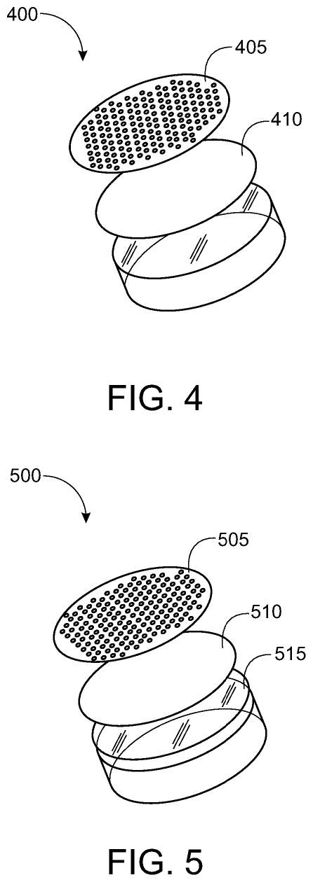

A Q-switch optical element 200 including a frequency selective structure 205 is illustrated in FIG. 2. A Q-switch optical element 300 in which the frequency selective structure's periodic pattern of features is provided in a switching component 305 is illustrated in FIG. 3. An exploded view of a Q-switch optical element 400 including a frequency selective structure 405 and a switching component 410 is illustrated in FIG. 4. An exploded view of a Q-switch optical element 500 including a frequency selective structure 505, a switching component 510, and a signal transmission component 515 configured to receive the signal and transmit the signal to the switching component is illustrated in FIG. 5. The signal transmission component 515 may comprise, for example, indium tin oxide, a patterned metal such as gold, patterned silicon, gallium arsenide and/or another semiconductor material. The signal transmission component 515 may comprise multiple layers. Different layers of the signal transmission component 515 may comprise different materials. If an optical signal is used to control the frequency response of the optical element, then no signal transmission component 515 may be necessary. The optical switching energy may be applied separately from the Q-switch optical element.

The frequency selective structures, switching components and signal transmission component of FIGS. 2-5 could be formed from a variety of different materials to achieve an optical element having the same or different frequency responses. The following passages provide examples of possible implementations.

A first possible implementation is an optical element comprising a phase change material configured to change phase upon receipt of a signal. The phase change material may incorporated into the optical element, e.g. as the switching component. The term “phase change material” covers a broad range of compounds that undergo a physical change when exposed to an external stimulus. Phase change materials are used in a wide variety of applications such as random access memory devices, compact discs (CDs) and digital versatile discs (DVDs), and smart windows. The chalcogenide glass used in random access memory devices changes between amorphous and crystalline states.

During such a transition, the resistivity may be caused to change on a microscopic level in response to an electrical stimulus. The chalcogenide glass (e.g. GeSbTe) is used in compact discs where an optical stimulus is used to change between amorphous and crystalline states to change the reflectivity of the surface. Smart windows use the insulator-to-metal phase transition of a sesquioxide (e.g. V₂O₃) to change the reflectivity with temperature.

The phase change material may be configured to change between being amorphous and being crystalline, or vice versa, upon receipt of the signal. The phase change material may be configured to change between being in an insulating phase and being in a metallic phase, or vice versa, upon receipt of the signal. Changing the phase of the phase change material may change an electromagnetic property (e.g. a refractive index and/or a conductivity and resistivity) of the frequency selective structure, thereby changing a transmissivity, reflectivity and/or absorptivity of the optical element. The phase change material may comprise vanadium dioxide (VO₂). VO₂ is a preferred phase change material for implementing a CO₂ laser Q-switch. The insulator-to-metal phase transition of VO₂ can be stimulated by thermal, electrical, or optical means. It has been shown that the insulator-to-metal phase transition can be stimulated by electrical or optical sources in the sub-microsecond time regime.

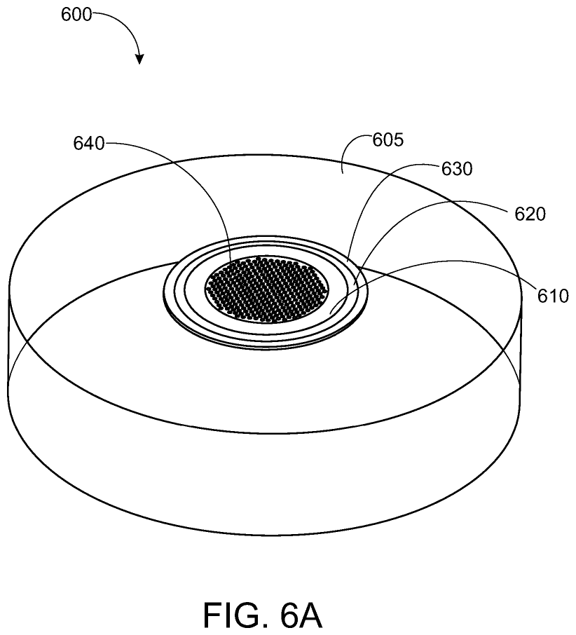

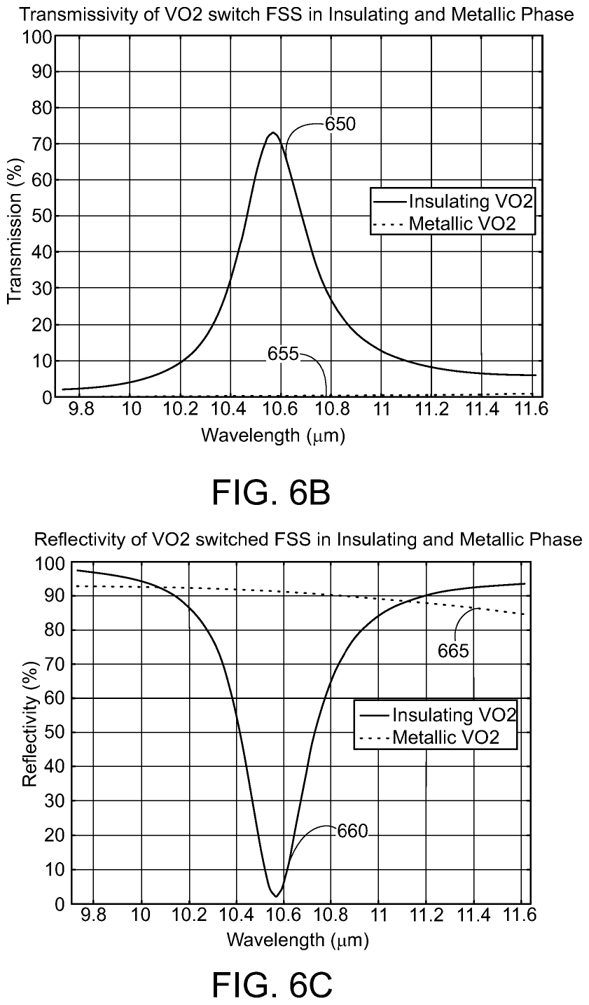

FIG. 6A schematically depicts a tunable optical element 600 comprising a substrate component 605, a frequency selective structure 610 and a switching component 620 comprising VO₂ (e.g. a layer of VO₂). The optical element 600 is capable of rapidly changing its frequency response upon receipt of a signal. The optical element 600 may therefore be used to Q-switch a laser (e.g. the laser of FIG. 1). The optical element 600 further comprises a signal transmission component 630 operably coupled to the switching component 620 configured to receive the signal and transmit the signal to the switching component 620. In the example of FIG. 6A, the signal transmission component 630 comprises indium tin oxide (ITO), the frequency selective structure 610 comprises an array of split-ring resonators 640 and the substrate 605 comprises ZnSe.

FIG. 6B illustrates the optical transmissivity frequency response of the optical element 600 of FIG. 6A in an insulating phase 650 before receipt of a signal and in a metallic phase 655 after receipt of the signal. The optical transmission frequency response of the optical element 600 is shown for wavelengths of radiation between about 9.7 μm and about 11.6 μm (i.e. within the infrared spectrum of wavelengths). The transmissivity of the optical element 600 in the insulating phase 650 is far greater than the transmissivity of the optical element 600 in the metallic phase 655 at about 10.6 μm.

FIG. 6C illustrates the optical reflectivity frequency response of the optical element 600 of FIG. 6A in an insulating phase 650 before receipt of a signal and in a metallic phase 655 after receipt of the signal. The optical reflection frequency response of the optical element 600 is shown for wavelengths of radiation between about 9.7 μm and about 11.6 μm (i.e. within the infrared spectrum of wavelengths). The reflectivity of the optical element 600 in the insulating phase 650 is far less than the reflectivity of the optical element 600 in the metallic phase 655 at about 10.6 μm.

FIGS. 6B and 6C show that the frequency response of the optical element 600 has changed dramatically due to the VO₂ changing from the insulating phase to the metallic phase upon receipt of the signal. If the optical element 600 formed part of a rear mirror of a CO₂ laser configured to generate pulses of radiation having a wavelength of about 10.6 μm, the optical element 600 could contribute to the laser having a high Q factor when the VO₂ is in the metallic phase by acting as a highly reflective rear mirror. The signal could be provided to change the phase of the VO₂ to the insulating phase and thereby decrease the Q factor of the laser by reducing the reflectivity of the rear mirror for a wavelength of about 10.6 μm. This would increase the number of photons being lost in the resonant cavity and prevent lasing from occurring whilst the gain medium is pumped. Once the gain medium is sufficiently pumped, another signal could be provided to change the VO₂ back into the metallic phase to allow lasing to occur and thereby generate a powerful pulse of radiation via Q switching.

A second possible implementation is an optical element comprising graphene, wherein an electrical permittivity of the graphene is configured to change upon receipt of a signal.

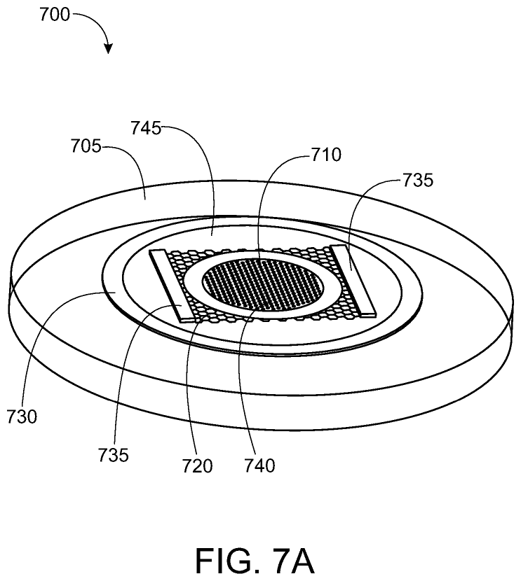

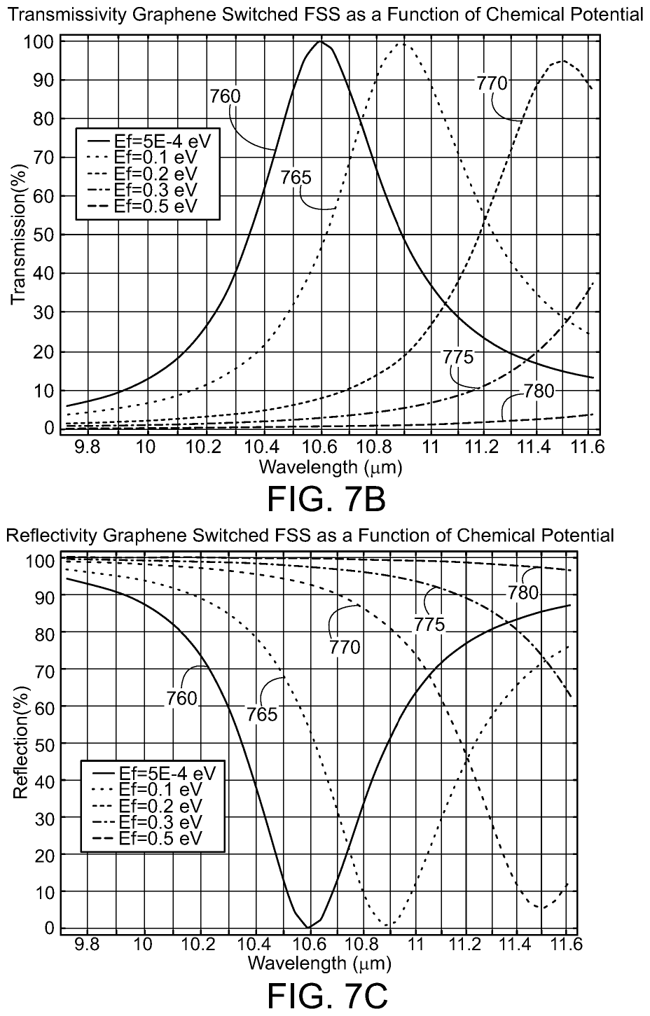

Graphene is a single atomic layer of carbon whose electric permittivity may be changed by the application of an electrical bias. As illustrated in FIG. 7A, an optical element 700 for Q-switching a laser may comprise a supporting structure or substrate 705, the frequency selective structure 710, a switching component 720 comprising graphene, a means for biasing the graphene 735, an electrically insulating material 745 and a signal transmission component 730. In the example of FIG. 7A, substrate 705 comprises ZnSe, the switching component 720 comprises a layer of graphene and the means for biasing the graphene 735 comprises two electrical contacts 735. The two electrical contacts 735 may be formed from at least one of, for example, gold, silver, nickel and/or aluminium.

The two electrical contacts 735 may be connected to a voltage source (not shown). The insulating material 745 may comprise at least one of, for example, SiO₂, HfO₂ and/or Al₂O₃. The signal transmission component 730 comprises indium tin oxide (ITO). The signal transmission component 730 may operate in a similar manner to a gate in a transistor. In this way, the electrical contacts 735 and the signal transmission component 730 may operate in a similar manner to a transistor. The signal transmission component 730 is optional. In alternative embodiments, the voltage signal may be switched directly and the single transmission component 730 may be omitted or grounded. The frequency selective structure 710 comprises an array of split-ring resonators 740. Alternatively or additionally, the graphene 720 may be lithographically processed to incorporate the periodic pattern of features 740 of the frequency selective structure 710. The biasing of the graphene 720 may cause a change in the electric permittivity of the optical element 700, thereby changing a transmissivity, reflectivity and/or absorptivity of the optical element 700.

FIG. 7B and FIG. 7C illustrate the change in the transmission and reflection frequency response respectively of the optical element 700 of FIG. 7A as a function of an applied bias Ef acting as the signal. FIGS. 7B and 7C show how the transmission and reflection frequency responses of the optical element 700 vary for wavelengths of between about 9.7 μm and about 11.6 μm at applied biases Ef of 5*10⁻⁴ eV 760, 0.1 eV 765, 0.2 eV 770, 0.3 eV 775 and 0.5 eV 780. FIG. 7B shows the transmission frequency response shift with changing biasing. Peak transmission of about 100% occurs at a wavelength of about 10.6 μm at a bias of 5*10⁻⁴ eV 760. Peak transmission of about 100% occurs at a wavelength of about 10.9 μm at a bias of 0.1 eV 765. Peak transmission of about 95% occurs at a wavelength of about 11.5 μm at a bias of 0.2 eV 770. A maximum transmission of about 40% is achievable across the wavelengths shown (at about 11.6 μm) at a bias of 0.3 eV 775. A maximum transmission of about 5% is achievable across the wavelengths shown (at about 11.6 μm) at a bias of 0.5 eV 780. An optical element 700 with such a tunable transmission frequency response could be implemented, for example, as the output coupler to Q-Switch a CO₂ laser.

FIG. 7C shows how the reflection null (i.e. a lowest reflectivity) in the frequency response of the optical element 700 shifts and the reflectivity at the CO₂ wavelength of 10.6 μm changes with changing biasing of the graphene. A lowest reflection of about 0% occurs at a wavelength of about 10.6 μm at a bias of 5*10⁻⁴ eV 760. A lowest reflection of about 0% occurs at a wavelength of about 10.9 μm at a bias of 0.1 eV 765. A lowest reflection of about 5% occurs at a wavelength of about 11.5 μm at a bias of 0.2 eV 770. A minimum reflection of about 60% is achievable across the wavelengths shown (at about 11.6 μm) at a bias of 0.3 eV 775. A minimum reflection of about 95% is achievable across the wavelengths shown (at about 11.6 μm) at a bias of 0.5 eV 780. An optical element 700 with this tunable reflection frequency response could be implemented, for example, as the rear mirror to Q-switch a CO₂ laser.

A third possible implementation is an optical element comprising a liquid crystal, wherein an optical property of the liquid crystal is configured to change upon receipt of a signal.

Liquid crystals are a family of materials that, under the right conditions of temperature and/or concentration, exhibit liquid and crystalline properties simultaneously. The optical properties of liquid crystals vary depending on the materials of the liquid crystal. A common characteristic of liquid crystals is birefringence, i.e., the polarization sensitive change in index of refraction with the application of a potential difference (i.e. a bias).

The application of voltage across the optical element comprising the liquid crystal may change the polarization characteristics and/or the refractive index of the liquid crystal, thereby changing a transmissivity, reflectivity and/or absorptivity of the optical element.

Variation in the optical properties of the liquid crystal due to the applied bias may change the transmissivity, reflectivity and/or absorptivity of the frequency selective structure.

Such an optical element comprising a liquid crystal such as E7 may be used to Q-switch a laser, e.g. a CO₂ laser.

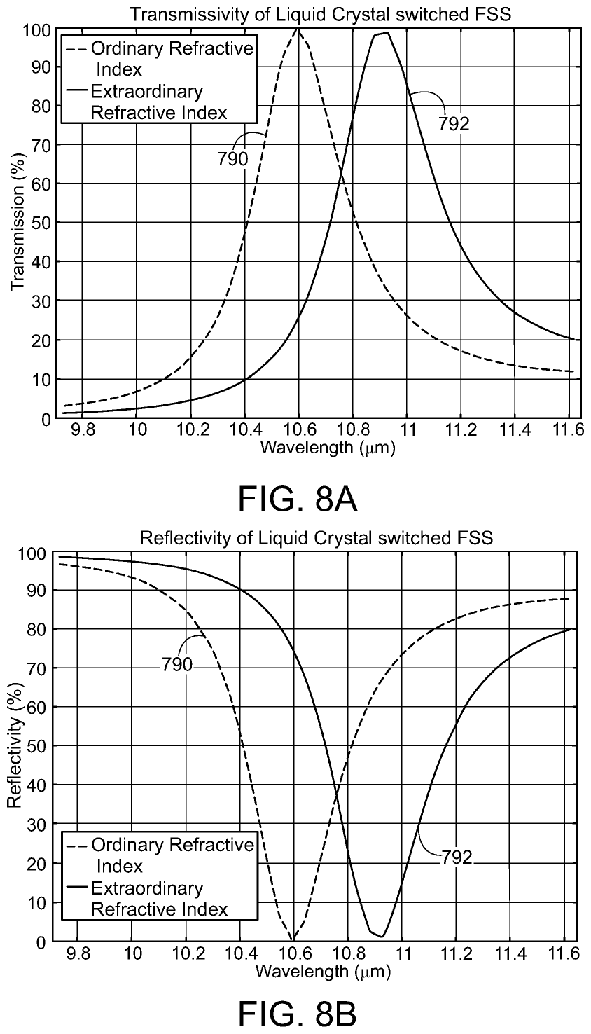

FIG. 8A illustrates the change in optical transmission frequency response due to birefringence of an optical element comprising a frequency selective structure, an E7 liquid crystal switching component and a supporting substrate comprising ZnSe. The optical transmission frequency response of the optical element is shown for wavelengths of radiation between about 9.7 μm and about 11.6 μm (i.e. within the infrared emission spectrum of wavelengths of a CO₂ laser). A bias voltage may be used to control the birefringence behaviour of the liquid crystal and thereby control the frequency response of the optical element. Without a bias voltage applied 790, a transmissivity peak of about 100% occurs at the primary CO₂ laser emission wavelength of about 10.6 μm. When a bias voltage is applied 792, the refractive index of the liquid crystal changes and the transmissivity peak of about 100% is shifted to about 10.9 μm whereas the transmissivity of the optical element at about 10.6 μm is reduced to about 25%. FIG. 8B shows the complimentary optical reflection frequency response for the optical element of FIG. 8A.

Without a bias voltage applied 790, a reflectivity trough of about 0% occurs at the primary CO₂ laser emission wavelength of about 10.6 μm. When a bias voltage is applied 792, the refractive index of the liquid crystal changes and the reflectivity trough of about 0% is shifted to about 10.9 μm whereas the reflectivity of the optical element at about 10.6 μm is increased to about 75%.

A laser output coupler comprising such a liquid crystal switched frequency selective structure could be used to Q-switch a laser. For example, if the optical element formed part of a output coupler of a CO₂ laser configured to generate pulses of radiation having a wavelength of about 10.6 μm, the optical element could contribute to the laser having a low Q factor when no bias voltage is applied (i.e. FIG. 8A) by acting as a highly transmissive output coupler. This would increase the amount of photons being lost within the resonant cavity and prevent lasing from occurring whilst the gain medium is pumped.

Once the gain medium is sufficiently pumped, another signal could be provided to apply a bias voltage to the liquid crystal (i.e. FIG. 8B) and thereby increase the Q factor of the laser by increasing the reflectivity of the output coupler and allow lasing to occur, thereby generating a powerful pulse of radiation at 10.6 μm via Q switching.

A fourth possible implementation is an optical element comprising a semiconductor, wherein a charge carrier density of the semiconductor is configured to change upon receipt of a signal (e.g., optical radiation or other electromagnetic field). The semiconductor may comprise Si, GaAs, Ge, InP, GaAlAs, and/or many others. The optical and electrical properties of semiconductors may be controlled by doping through the introduction of impurities in the lattice structure of the semiconductor. Using lithography and deposition technology, patterns and features can be created on substrates to perform a variety of functions. For example, a monolithic Q-switch optical element can be fabricated by incorporating the frequency selective structure and switching component into a single device. An advantage of using a semiconductor based design is that a metal-free structure can be fabricated having low-loss (i.e. low photon absorption at infrared wavelengths) and high efficiency. Changing the charge carrier density of the semiconductor may change a refractive index of the optical element, thereby changing a transmissivity, reflectivity and/or absorptivity of the optical element.

For example, a semiconductor material including a p-n junction may exhibit a first optical passband when unbiased such that free charge carriers are present within the bulk of the material. Reverse biasing the p-n junction may cause a depletion zone including few, if any, free charge carriers to develop, thereby altering the optical pass band of the semiconductor.

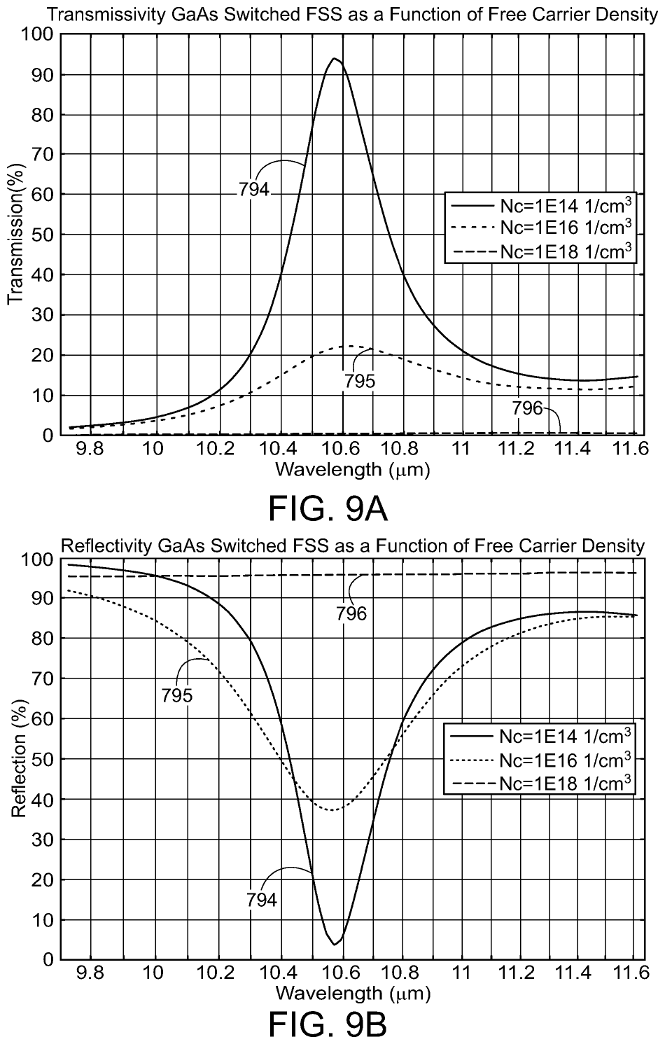

FIG. 9A illustrates the optical transmission frequency responses of an optical element comprising a frequency selective structure and a switching component comprising a semiconductor at three different values of charge carrier density 794-796. FIG. 9B illustrates the optical reflection frequency responses of the optical element of FIG. 9A at the three different values of charge carrier density 794-796. In the example of FIGS. 9A and 9B, the switching component comprises GaAs. The optical transmission and reflection frequency response of the optical element is shown for wavelengths of radiation between about 9.7 μm and about 11.6 μm (i.e. including the primary CO₂ laser emission wavelength of about 10.6 μm). A first charge carrier density 794 is about 10¹⁴ charge carriers per cubic centimetre. The first charge carrier density 794 may represent the optical element without an applied electromagnetic field or any applied electromagnetic radiation (i.e. before the receipt of a signal to switch the frequency response of the optical element). A second charge carrier density 795 is about 10¹⁶ charge carriers per cubic centimetre. The second charge carrier density 795 may represent the optical element after the application of a first electromagnetic field or a first electromagnetic radiation (i.e. after the receipt of a first signal to switch the frequency response of the optical element). A third charge carrier density 796 is about 10¹⁸ charge carriers per cubic centimetre. The third charge carrier density 796 may represent the optical element after the application of a second electromagnetic field or second electromagnetic radiation (i.e. after the receipt of a second signal to switch the frequency response of the optical element). A magnitude of the second electromagnetic field or second electromagnetic radiation may be greater than a magnitude of the first electromagnetic field or first electromagnetic radiation.

With reference to both FIG. 9A and FIG. 9B, in the first (i.e. the lowest) charge carrier density state 794, the transmissivity of the optical element at the primary wavelength of a CO₂ laser of about 10.6 μm is at its highest value of about 93% and the reflectivity of the optical element is at its lowest value of about 3%. When the charge density increases to the second charge carrier density 795 after receipt of the first signal, the transmissivity of the optical element at about 10.6 μm decreases to about 22% and the reflectivity of the optical element increases to about 38% (i.e. a frequency response of the optical element changes). When the charge carrier density increases to the third (i.e. the highest) charge carrier density state 796 after receipt of the second signal, the transmissivity of the optical element decreases to about 0% and the reflectivity of the optical element increases to about 96%. Thus, the frequency response of the optical element may be tuned by the application of an electromagnetic field or electromagnetic radiation to adjust a charge carrier state of the semiconductor switching component.

If the optical element formed part of a rear mirror of a CO₂ laser configured to generate pulses of radiation having a wavelength of about 10.6 μm, the optical element could contribute to the laser having a low Q factor when no electromagnetic field or electromagnetic radiation is applied by acting as a highly transmissive rear mirror. This would increase the number of photons lost in the resonant cavity and prevent lasing from occurring whilst the gain medium is pumped. The signal could be provided to remove the reverse bias from the GaAs semiconductor. Once the gain medium is sufficiently pumped, the signal could be provided to apply an electromagnetic field or electromagnetic radiation to the GaAs semiconductor switching component to increase the Q factor of the laser by increasing the reflectivity of the rear mirror comprising the optical element for a wavelength of about 10.6 μm and allow lasing to occur. This would generate a powerful pulse of radiation at 10.6 μm via Q switching provided by the optical element.

The possible implementations discussed above are just a few of the many ways of configuring and switching a Q-switch optical element comprising a frequency selective structure.

The frequency selective structure of the optical element may take many different forms.

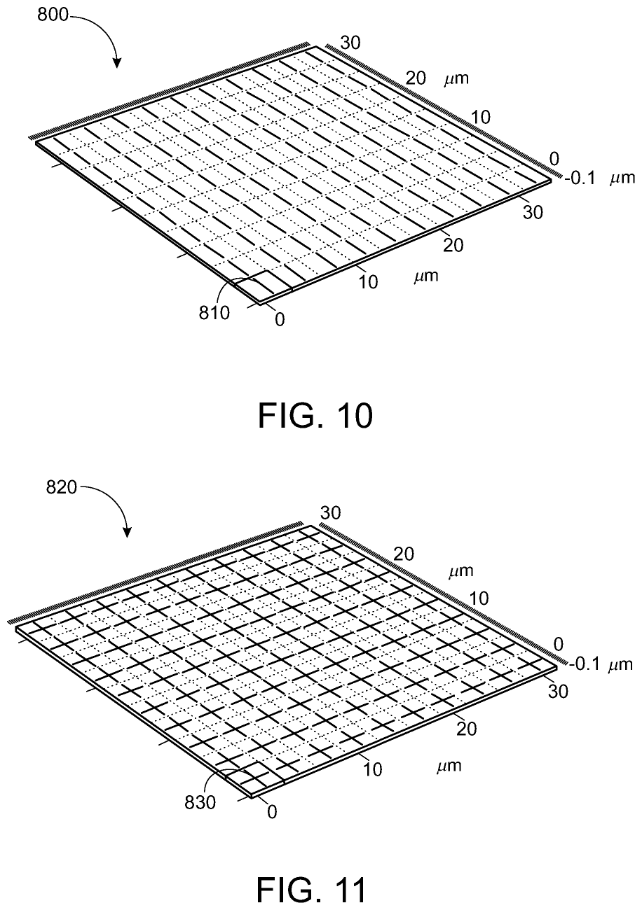

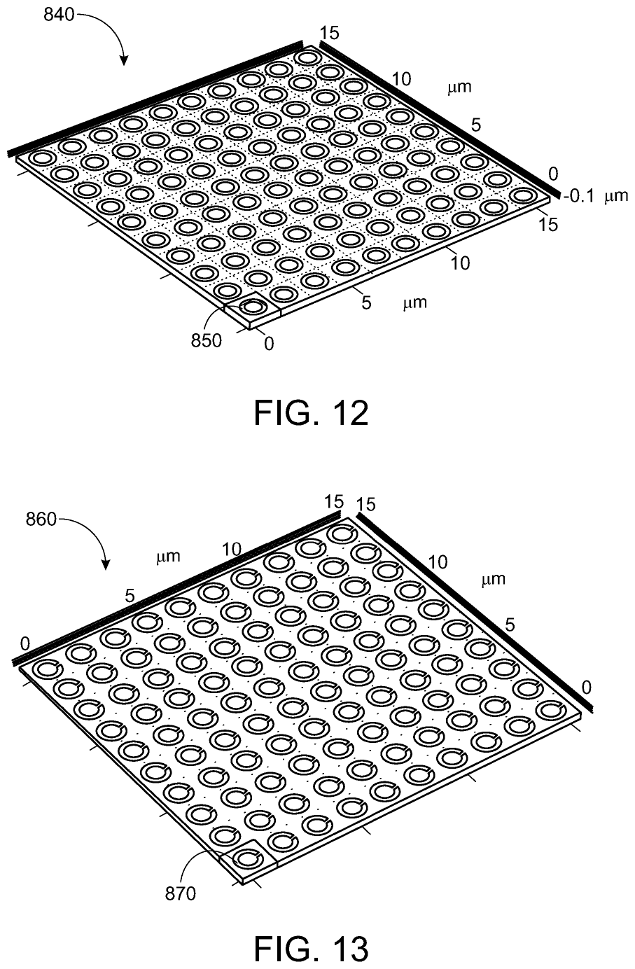

FIGS. 10-13 provide four different examples of portions of frequency selective structures comprising arrays of different geometric features that may form part of any previously described optical element. FIG. 10 schematically depicts a perspective view from above a portion of a frequency selective structure 800 comprising a periodic pattern of slots 810 according to an aspect of the present disclosure. In the example of FIG. 10, the periodic pattern comprises a ten-by-ten grid array of slots 810 having a periodicity of about 3 μm that forms a frequency selective structure 800 having a length of about 30 μm and a width of about 30 μm. FIG. 11 schematically depicts a perspective view from above a portion of a frequency selective structure 820 comprising a periodic pattern of crosses 830 according to an aspect of the present disclosure. In the example of FIG. 11, the periodic pattern takes the form of a ten-by-ten grid array of crosses 830 having a periodicity of about 3 μm that forms a frequency selective structure 820 having a length of about 30 μm and a width of about 30 μm. FIG. 12 schematically depicts a perspective view from above a portion of a frequency selective structure 840 comprising a periodic pattern of rings 850 according to an aspect of the present disclosure. In the example of FIG. 12, the periodic pattern comprises a ten-by-ten grid array of rings 850 having a periodicity of about 1.5 μm that forms a frequency selective structure 840 having a length of about 15 μm and a width of about 15 μm. FIG. 13 schematically depicts a perspective view from above a portion of a frequency selective structure 860 comprising a periodic pattern of split rings 870 according to an aspect of the present disclosure. In the example of FIG. 13, the periodic pattern comprises a ten-by-ten grid array of split rings 870 having a periodicity of about 1.5 μm that forms a frequency selective structure 860 having a length of about 15 μm and a width of about 15 μm.

A size of any of the frequency selective structures (e.g. a number and/or size of individual array components and/or a periodicity of the array) may be selected at least partially based on a beam size of a laser beam that is to be incident upon the frequency selective structure. In any of FIGS. 10-13 the geometric features may be formed using additive or reductive manufacturing techniques such as lithography, deposition, etching, nano-imprinting, etc. FIGS. 10-13 show portions of frequency selective structures that may form part of an optical element according to an aspect of the present disclosure. In practice, the frequency selective structures may be larger than those shown in FIGS. 10-13. For example, when used to Q-switch a laser, the arrays may be approximately 3 mm by 3 mm. That is, an optical element may incorporate about ten thousand of the arrays shown in FIGS. 10-13.

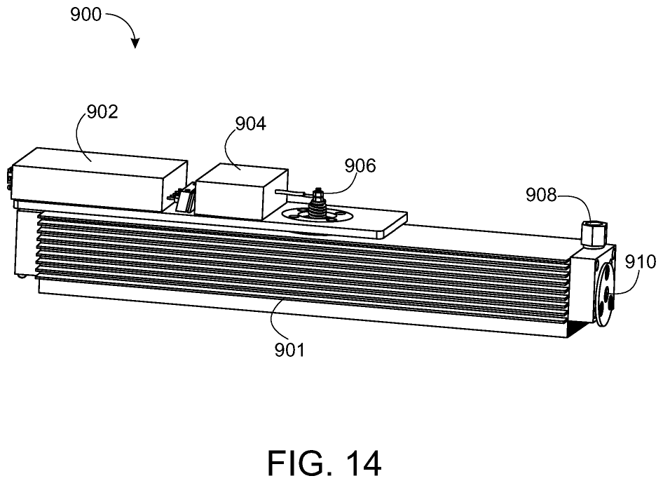

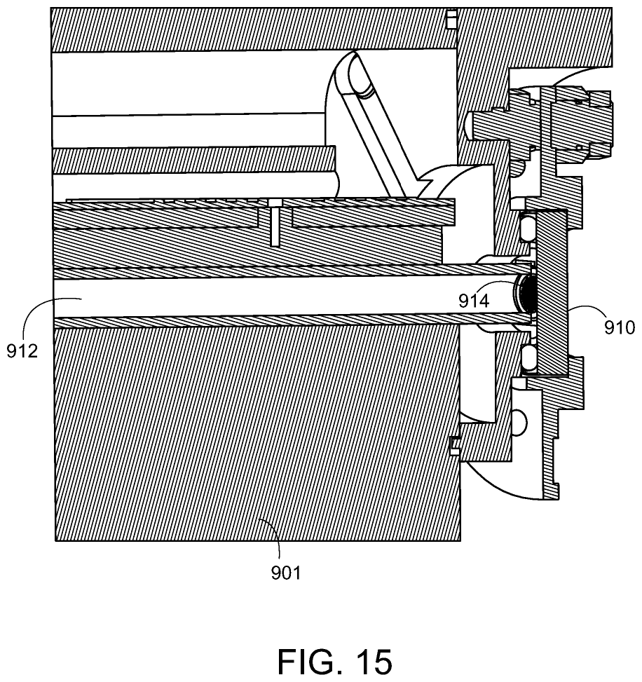

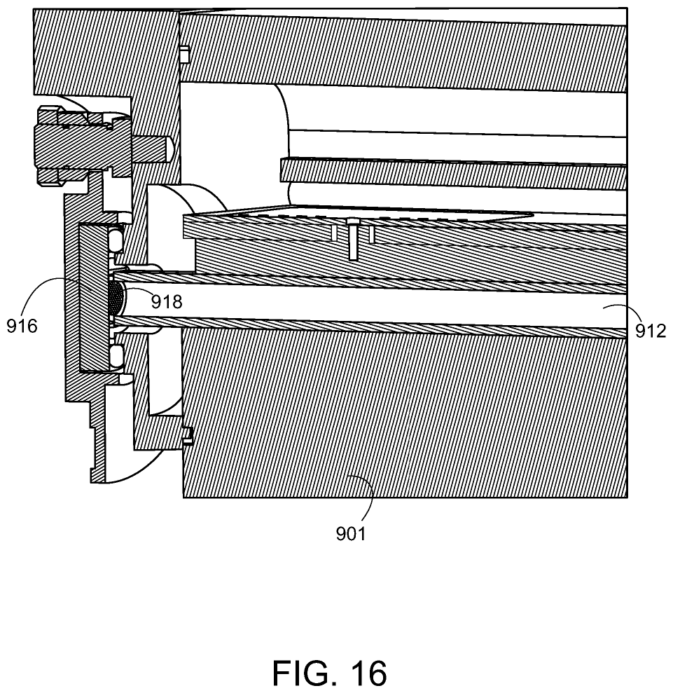

FIG. 14 schematically depicts a perspective view from the side of a CO₂ laser 900 according to an aspect of the present disclosure. The CO₂ laser 900 is configured to produce infrared electromagnetic radiation (not shown). The CO₂ laser 900 comprises an optical element (not shown) comprising a frequency selective structure having a substantially periodic pattern of features. A frequency response of the optical element is configured to change upon receipt of a signal, and a Q-factor of the CO₂ laser 900 changes upon receipt of the signal. The optical element may be any of the optical elements described above and depicted in FIGS. 2-6A and 7A, comprising any of the frequency selective structures described above and depicted in FIGS. 10-13.

The CO₂ laser 900 comprises a laser cavity 901 comprising a CO₂ gain medium (not visible in FIG. 14). The CO₂ laser 900 comprises a radio frequency (“RF”) excitation source 904 configured to excite the CO₂ gain medium in the laser cavity 901 to produce the infrared electromagnetic radiation. The RF excitation source 904 may be configured to provide RF power of about 150 W or more. The RF excitation source 904 may be configured to provide RF power of about 1 kW or less. The RF excitation source 904 may be configured to provide RF power at a frequency of about 80 MHz or more. The RF excitation source 904 may be configured to provide RF power at a frequency of about 120 MHz or less. The RF excitation source 904 may be configured to provide RF power at a frequency of about 100 MHz or more. The RF excitation source 904 may be configured to provide RF power to the CO₂ gain medium for a duration of about 0.1 μsec or more. The RF excitation source 904 may be configured to provide RF power to the CO₂ gain medium for a duration of about 1.0 μsec or less. The RF excitation source 904 may be configured to provide RF power to the CO₂ gain medium continuously. A pulse duration of the RF excitation source 904 may be controlled by user of the CO₂ laser. A pulse duration of the RF excitation source 904 may be at least partially dependent on one or more of the desired laser energy (e.g. pulse energy), an average power of the CO₂ laser 900, a pulse repetition frequency and, in the use case of a laser marking system, a product throughout rate.

The CO₂ laser 900 may be configured to produce infrared electromagnetic radiation having an average power of about 10 W. The CO₂ laser 900 may be configured to produce infrared electromagnetic radiation having an average power of about 30 W. The CO₂ laser 900 may be configured to produce infrared electromagnetic radiation having an average power of about 50 W. The CO₂ laser 900 may be configured to produce infrared electromagnetic radiation having an average power of about 100 W. The CO₂ laser 900 may be configured to produce short-pulsed infrared electromagnetic radiation.

The CO₂ laser 900 may be configured to produce a short pulse (pulse width >0.1 nsec and <500 μsec) of infrared electromagnetic radiation.

The CO₂ laser 900 comprises a control system 902 configured to provide the signal to the optical element to Q-switch the CO₂ laser 900. The signal may comprise a bias voltage. The bias voltage may be greater than 0 V. The bias voltage may be less than or equal to about 20 V. The bias voltage may be applied for about 1 ns or more. The bias voltage may be applied for about 150 ns or less. A duration for which the bias voltage is applied may be selected in at least partial dependence on a desired output energy (e.g. laser pulse energy) to be generated by the CO₂ laser 900. Alternatively, the signal may comprise a laser pulse. The laser pulse may be produced by a short-pulsed laser diode. The control system 902 is also configured to provide a separate control signal to the RF excitation source 904 to excite the CO₂ gain medium in the laser cavity 901. The signal may be configured to control a bias level of a switching component of the optical element. The signal may be configured to control a timing between a laser output command of the CO₂ laser 900 and an initiation of Q-switching of the CO₂ laser 900.

The CO₂ laser 900 comprises a feedthrough 906 configured to transmit power from the RF excitation source 904 to the CO₂ gain medium in the laser cavity 901. The CO₂ laser 900 comprises a fluid input 908 for filling the laser cavity 901 with CO₂ gas. The CO₂ laser 900 comprises an output coupler 910. The output coupler 910 may comprise a partially reflecting mirror configured to output infrared electromagnetic radiation (e.g. pulses of infrared electromagnetic radiation) generated by the CO₂ laser 900. The CO₂ laser comprises a rear mirror (not visible in FIG. 14) that opposes the output coupler 910 such that the CO₂ gain medium is located between the output coupler 910 and the rear mirror. That is, the laser cavity 901 comprising CO₂ gain medium is formed between the rear mirror and the output coupler 901. The optical element comprising the frequency selective structure may be located at a number of different locations in the CO₂ laser 900. FIGS. 15-17 show different examples of where the optical element may be located in the CO₂ laser.

FIG. 15 schematically depicts a cross-sectional view of an output coupler of the CO₂ laser of FIG. 14. Infrared electromagnetic radiation (not shown) generated by the CO₂ laser propagates along a bore 912 within the laser cavity 901 and interacts with the output coupler 910. The bore may be formed of, for example, alumina. The output coupler 910 may be formed of, for example, ZnSe. The output coupler 910 reflects some of the infrared electromagnetic radiation back through the bore 912 towards the rear mirror (not shown). The output coupler 910 also transmits some of the infrared electromagnetic radiation to outside of the laser cavity 901 as output laser light. In the example of FIG. 15, the optical element 914 comprising a frequency selective structure having a substantially periodic pattern of features forms part of the output coupler 910 of the CO₂ laser. As previously described, a frequency response of the optical element 914 is configured to change upon receipt of a signal such that a Q-factor of the CO₂ laser changes upon receipt of the signal. The optical element 914 may comprise ZnSe, GaAs, Ge or ZnS. These transmissive base materials are compatible with the CO₂ laser plasma present in the bore 912 of the laser cavity 901. A complex index of refraction (n+jk) of the ZnSe at a wavelength of about 10.6 μm may be about (2.4028). A complex index of refraction (n+jk) of the GaAs at a wavelength of about 10.6 μm may be about (3.2646+j0.00029). A complex index of refraction (n+jk) of the Ge at a wavelength of about 10.6 μm may be about (4.0038). A complex index of refraction (n+jk) of the ZnS at a wavelength of about 10.6 μm may be about (2.1925+j0.002).

FIG. 16 schematically depicts a cross-sectional view of a rear mirror 916 of the CO₂ laser of FIG. 14. Infrared electromagnetic radiation (not shown) generated by the CO₂ laser propagates along the bore 912 within the laser cavity 901 and interacts with the rear mirror 916. The rear mirror 916 is configured to reflect substantially all of the infrared electromagnetic radiation back through the bore 912 towards the output coupler (not shown). The rear mirror 916 may, for example, be formed of Silicon. In the example of FIG. 16, the optical element 918 comprising a frequency selective structure having a substantially periodic pattern of features forms part of the rear mirror 916 of the CO₂ laser. As previously described, a frequency response of the optical element 918 is configured to change upon receipt of a signal such that a Q-factor of the CO₂ laser changes upon receipt of the signal. In the example of FIG. 15 the optical element 918 forms part of an output coupler configured to at least partially transmit infrared electromagnetic radiation, whereas in the example of FIG. 16 the optical element 918 forms part of a rear mirror 916 configured to reflect infrared electromagnetic radiation.

As such, the optical element 918 of FIG. 16 is formed of a different material to the optical element 916 of FIG. 15. It will be appreciated that the two implementations shown in FIGS. 15 and 16 would not be used simultaneously. The optical element 918 of FIG. 16 may, for example, comprise Silicon or GaAs. These reflective base materials are compatible with the CO₂ laser plasma present in the bora 912 of the laser cavity 901. A complex index of refraction (n+jk) of the silicon at a wavelength of about 10.6 μm may be about (3.4179+j0.0001223). A complex index of refraction (n+jk) of the GaAs at a wavelength of about 10.6 μm may be about (3.2646+j0.00029).

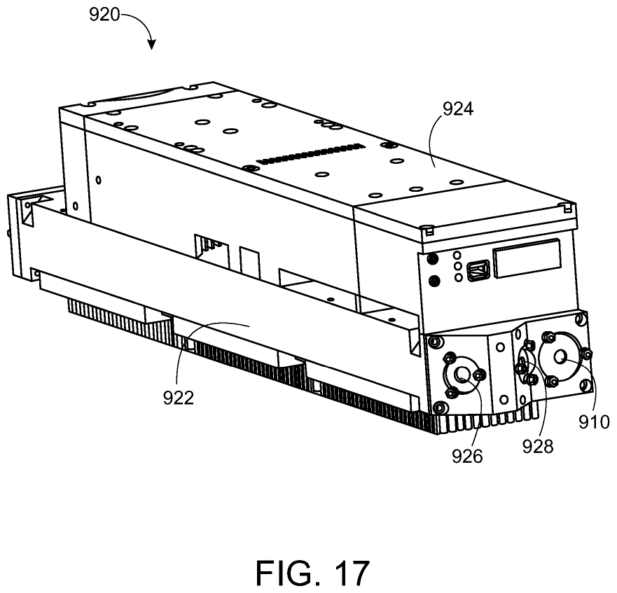

FIG. 17 schematically depicts a perspective view of a CO₂ laser 920 comprising a folded cavity 922 according to an aspect of the present disclosure. The CO₂ laser 920 is configured to produce infrared electromagnetic radiation (not shown). The CO₂ laser 920 comprises an optical element (not shown) comprising a frequency selective structure having a substantially periodic pattern of features. A frequency response of the optical element is configured to change upon receipt of a signal, and a Q-factor of the CO₂ laser 920 changes upon receipt of the signal. The optical element may be any of the optical elements described above and depicted in FIGS. 2-6A and 7A, comprising any of the frequency selective structures described above and depicted in FIGS. 10-13.

The folded laser cavity 922 comprises a CO₂ gain medium (not visible in FIG. 17). The CO₂ laser 920 comprises a radio frequency (“RF”) excitation source (not shown) configured to excite the CO₂ gain medium in the folded laser cavity 922 to produce the infrared electromagnetic radiation. The RF excitation source may be substantially the same as the RF excitation source 904 described above with reference to FIG. 14, the details of which will not be repeated here to avoid unnecessary duplication.

The CO₂ laser 920 may be configured to produce infrared electromagnetic radiation having an average power of about 10 W. The CO₂ laser 920 may be configured to produce infrared electromagnetic radiation having an average power of about 30 W. The CO₂ laser 920 may be configured to produce infrared electromagnetic radiation having an average power of about 50 W. The CO₂ laser 920 may be configured to produce infrared electromagnetic radiation having an average power of about 100 W. The CO₂ laser 900 may be configured to produce short-pulsed infrared electromagnetic radiation.

The CO₂ laser 900 may be configured to produce a short pulse (pulse width >0.1 nsec and <500 μsec) of infrared electromagnetic radiation.

The CO₂ laser 920 comprises a control system 924 configured to provide the signal to the optical element to Q-switch the CO₂ laser 920. The signal may comprise a bias voltage. The bias voltage may be greater than 0 V. The bias voltage may be less than or equal to about 20 V. The bias voltage may be applied for about 1 ns or more. The bias voltage may be applied for about 100 μs or less. The bias voltage may be applied for about 150 ns or less. A duration for which the bias voltage is applied may be selected in at least partial dependence on a desired output energy (e.g. laser pulse energy) to be generated by the CO₂ laser 920. Alternatively, the signal may comprise a laser pulse.

The laser pulse may be produced by a short-pulsed laser diode. The control system 924 is also configured to provide a separate control signal to the RF excitation source to excite the CO₂ gain medium in the folded laser cavity 922.

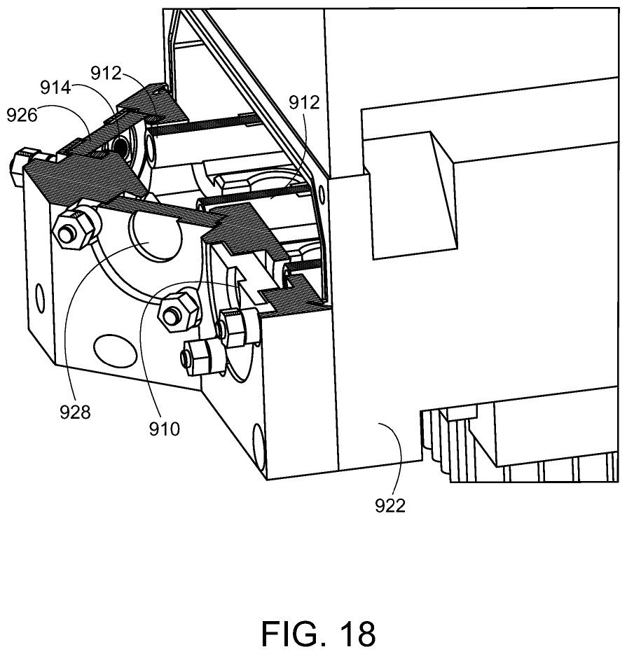

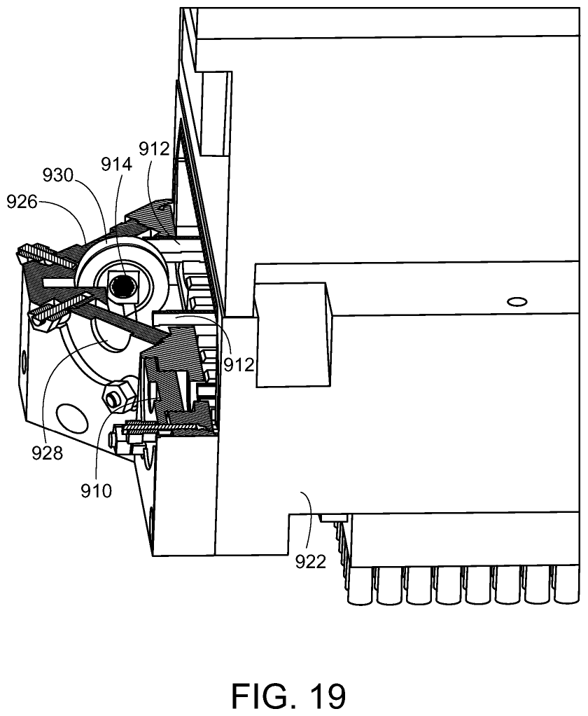

The CO₂ laser 900 comprises an output coupler 910. The output coupler 910 may comprise a partially reflecting mirror configured to output infrared electromagnetic radiation (e.g. pulses of infrared electromagnetic radiation) generated by the CO₂ laser 920. The CO₂ laser 920 comprises a plurality of fold mirrors 926, 928. In the example of FIG. 17, the CO₂ laser 920 comprises four fold mirrors 926, 928, of which two are visible. The fold mirrors 926, 928 are configured to direct the infrared electromagnetic radiation along parallel lengths of the folded cavity 922. The CO₂ laser 920 comprises a rear mirror (not visible in FIG. 17) that opposes one of the fold mirrors 926 such that the CO₂ gain medium is located between the output coupler 910 and the rear mirror. That is, the folded laser cavity 922 comprising CO₂ gain medium is formed between the rear mirror and the output coupler 910. The optical element comprising the frequency selective structure may be located at a number of different locations in the CO₂ laser 920 comprising a folded cavity 922. FIGS. 18 and 19 show different examples of where the optical element may be located in the CO₂ laser 920.

FIG. 18 schematically depicts a cross-sectional view of two of the fold mirrors 926, 928 and the output coupler 910 of the CO₂ laser of FIG. 17. Infrared electromagnetic radiation (not shown) generated by the CO₂ laser propagates along bores 912 within the folded laser cavity 922 and interacts with the output coupler 910. The bores 912 may be formed of, for example, alumina. The output coupler 910 may be formed of, for example, ZnSe. The output coupler 910 reflects some of the infrared electromagnetic radiation back through the bores 912 towards the rear mirror (not shown). The output coupler 910 also transmits some of the infrared electromagnetic radiation to outside of the folded laser cavity 922 as output laser light. In the example of FIG. 18, the optical element 914 comprising a frequency selective structure having a substantially periodic pattern of features forms part of one of the fold mirrors 926 of the CO₂ laser. As previously described, a frequency response of the optical element 914 is configured to change upon receipt of a signal such that a Q-factor of the CO₂ laser changes upon receipt of the signal. The optical element 914 may comprise silicon or GaAs. These reflective base materials are compatible with the CO₂ laser plasma present in the bores 912 of the folded cavity 922. A complex index of refraction (n+jk) of the silicon at a wavelength of about 10.6 μm may be about (3.4179+j0.0001223). A complex index of refraction (n+jk) of the GaAs at a wavelength of about 10.6 μm may be about (3.2646+j0.00029).

FIG. 19 schematically depicts a cross-sectional view of two of the fold mirrors 926, 928 and the output coupler 910 of the CO₂ laser of FIG. 17, further comprising a passive optical component 930 according to an aspect of the present disclosure. In the example of FIG. 19, the optical element 914 comprising a frequency selective structure having a substantially periodic pattern of features forms part of the passive optical component 930. As previously described, a frequency response of the optical element 914 is configured to change upon receipt of a signal such that a Q-factor of the CO₂ laser changes upon receipt of the signal. The passive optical component 930 is located in the folded laser cavity 922 of the CO₂ laser. In the example of FIG. 19, the passive optical component 930 is located between two of the fold mirrors 926, 928 of the CO₂ laser. The passive optical element 930 may be located in other locations within the folded cavity 922 of the CO₂ laser. In the example of FIG. 19, the passive optical component 930 comprises a transmissive disk upon which the optical element 914 is mounted. The passive optical component 930 may comprise, for example, ZnSe, GaAs, Ge or ZnS.

The optical element may, for example, comprise ZnSe, GaAs, Ge or ZnS. These transmissive base materials are compatible with the CO₂ laser plasma present in the bores 912 of the folded cavity 922 of the CO₂ laser. A complex index of refraction (n+jk) of the ZnSe at a wavelength of about 10.6 μm may be about (2.4028). A complex index of refraction (n+jk) of the GaAs at a wavelength of about 10.6 μm may be about (3.2646+j0.00029). A complex index of refraction (n+jk) of the Ge at a wavelength of about 10.6 μm may be about (4.0038). A complex index of refraction (n+jk) of the ZnS at a wavelength of about 10.6 μm may be about (2.1925+j0.002).

In the examples of FIGS. 15, the optical element 914 comprises graphene. An electric permittivity of the graphene may be configured to change upon receipt of the signal. A complex index of refraction (n+jk) of the graphene at a wavelength of about 10.6 μm may change between about (4.45−j4.34) and about (14.43−j0.08) upon receipt of the signal.

In the example of FIGS. 15, 16, 18 and 19, the optical element comprises graphene. An electric permittivity of the graphene may be configured to change upon receipt of the signal used to Q-switch the CO₂ laser. A complex index of refraction (n+jk) of the graphene at a wavelength of about 10.6 μm may change between about (4.45−j4.34) and about (14.43−j0.08) upon receipt of the signal. The optical element may comprises different materials. For example, the optical element 914 may comprise a phase change material configured to change phase upon receipt of the signal. The phase change material may, for example, comprise VO₂. A complex index of refraction (n+jk) of the VO₂ at a wavelength of about 10.6 μm may change between about (2.1+j0.16) in an insulating state to about (7.8+j 5.8) in a metallic state upon receipt of the signal.

Alternatively, the optical element 914 may comprise a semiconductor. A charge carrier density of the semiconductor may be configured to change upon receipt of the signal.

The semiconductor may comprise, for example, GaAs, Si, or Ge. When the signal provided to the optical element to Q-switch the CO₂ laser is a laser pulse, the semiconductor may form part of a photoconductive device configured to interact with the laser pulse.

As described above, the optical element may comprise a signal transmission component operably coupled to the switching component configured to receive the signal and transmit the signal to the switching component. The signal transmission component may comprise a layer of conductive material. The layer of conductive material may comprise at least one of gold, nickel, aluminium, and indium tin oxide (ITO). The optical element may comprise an insulating material. The insulating material may comprise, for example, one or more of aluminium oxide and hafnium oxide. The insulating material may comprise other materials.

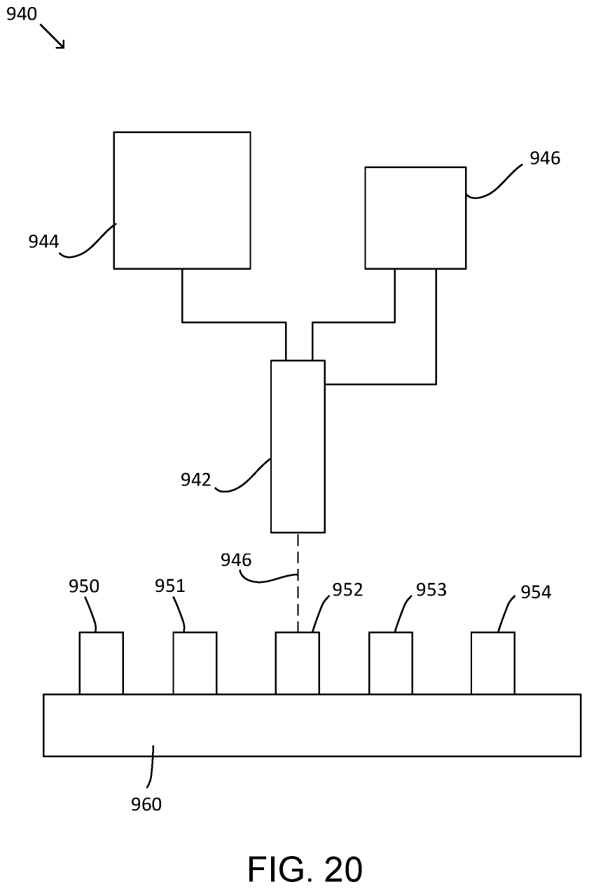

FIG. 20 schematically depicts a laser marking system 940 comprising a CO₂ laser 942 according to an aspect of the present disclosure. The CO₂ laser may be the same as either of the the CO₂ lasers described above and depicted in FIGS. 14-19, which will not be described again here to avoid unnecessary duplication. The laser marking system 940 comprises a power supply 944 configured to provide the CO₂ laser 942 with power.

The laser marking system 940 comprises a control system 946 configured to provide the signal to the optical element to Q-switch the CO₂ laser 942 and provide a separate control signal to excite the CO₂ gain medium in the CO₂ laser. In the example of FIG. 20, the infrared electromagnetic radiation 946 generated by the CO₂ laser 942 is configured to mark a product 952. The CO₂ laser 942 may be configured to generate pulses of infrared electromagnetic radiation 946. The product 952 may be one of a plurality of products 950-954 moving along a production line 960 (e.g. a conveyor belt).

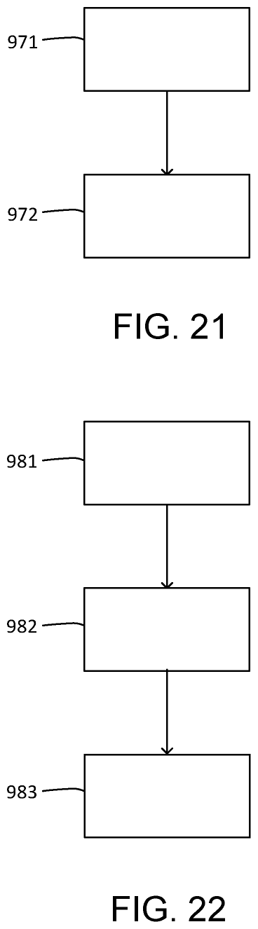

FIG. 21 shows a flowchart of a method of Q-switching a CO₂ laser to produce infrared electromagnetic radiation according to an aspect of the present disclosure. A first step 971 of the method comprises exciting a CO₂ gain medium of the CO₂ laser. A second step 972 of the method comprises generating a signal to change a frequency response of a frequency selective structure having a substantially periodic pattern of features on an optical element of the CO₂ laser and thereby produce a pulse of infrared electromagnetic radiation. Generating the signal may comprise operating a controller to produce an electric signal or an optical signal (e.g. a laser pulse). The infrared electromagnetic radiation generated by the method may be configured to mark a product.

The method may comprise an optional step of producing short-pulsed infrared electromagnetic radiation. The CO₂ laser may be configured to produce a short pulse (pulse width >0.1 nsec and <500 μsec) of infrared electromagnetic radiation.

FIG. 22 shows a method of marking a target with infrared electromagnetic radiation according to an aspect of the present disclosure. A first step 981 of the method comprises exciting a CO₂ gain medium of the CO₂ laser. A second step 982 of the method comprises generating a signal to Q-switch the CO₂ laser by changing a frequency response of a frequency selective structure having a substantially periodic pattern of features on an optical element of a CO₂ laser, thereby producing a pulse of infrared electromagnetic radiation. A third step of the method 983 comprises directing the pulse of infrared electromagnetic radiation to the target. Generating the signal may comprise operating a controller to produce an electric signal or an optical signal (e.g. a laser pulse). The method may comprise an optional step of producing short-pulsed infrared electromagnetic radiation. The CO₂ laser may be configured to produce a short pulse (pulse width >0.1 nsec and <500 μsec) of infrared electromagnetic radiation.

It will be appreciated that the CO₂ laser described herein may be used in many different applications. The CO₂ laser may be used in industrial applications such as, for example, laser marking and coding, engraving, drilling, cutting, drilling, welding (metal and plastic), surface treatment (laser peening, hardening, polishing, roughening, blackening), rust removal, paint removal, etc. The CO₂ laser may be used in medical application such as, for example, as a laser scalpel, otolaryngology and head and neck surgical procedures, gynaecologic surgery, lesion and tumour removal, vascular surgery, oral soft tissue surgery, enamel ablation, implant dentistry, tattoo removal, laser-evoked nociceptive potentials for migraine treatment, burn scar treatment, skin resurfacing, birthmark removal, mole and viral wart removal, skin aging, removal of facial scaring, etc. The desired power provided by the CO₂ laser at least partially depends upon the application on the CO₂ laser. For example, for soft material applications, such as most surgeries, the CO₂ laser may produce infrared electromagnetic radiation having a power in the range of 10-20 W. As another example, for some metal laser processing applications the CO₂ laser may produce infrared electromagnetic radiation having a power in the range of 40-50 W. As a further example, for some plastic laser processing applications the CO₂ laser may produce infrared electromagnetic radiation having a power of about 30 W.

Having thus described several aspects of at least one implementation, it is to be appreciated that various alterations, modifications, and improvements will readily occur to those skilled in the art. Such alterations, modifications, and improvements are intended to be part of this disclosure, and are intended to be within the spirit and scope of the disclosure. The acts of methods disclosed herein may be performed in alternate orders than illustrated, and one or more acts may be omitted, substituted, or added. One or more features of any one example disclosed herein may be combined with or substituted for one or more features of any other example disclosed. Accordingly, the foregoing description and drawings are by way of example only.

The phraseology and terminology used herein is for the purpose of description and should not be regarded as limiting. As used herein, the term “plurality” refers to two or more items or components. As used herein, dimensions which are described as being “substantially similar” should be considered to be within about 25% of one another. The terms “comprising,” “including,” “carrying,” “having,” “containing,” and “involving,” whether in the written description or the claims and the like, are open-ended terms meaning “including but not limited to.” Thus, the use of such terms is meant to encompass the items listed thereafter, and equivalents thereof, as well as additional items. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A carbon dioxide (CO₂) laser configured to produce infrared electromagnetic radiation comprising:
an optical element comprising a frequency selective structure having a substantially periodic pattern of features, wherein a frequency response of the optical element is configured to change upon receipt of a signal,
wherein a Q-factor of the CO₂ laser changes upon receipt of the signal,
wherein the optical elemene comprises graphene.

2. The CO₂ laser of claim 1, comprising:
a laser cavity comprising a CO₂ gain medium;
a radio frequency excitation source configured to excite the CO₂ gain medium to produce infrared electromagnetic radiation, and
a control system configured to:
provide the signal to the optical element to Q-switch the CO₂ laser; and
provide a separate control signal to the radio frequency excitation source to excite the CO₂ gain medium.

3. (canceled)

4. The CO₂ laser of a claim 1, wherein the optical element forms part of a rear mirror of the CO₂ laser.

5. The CO₂ laser of claim 1, comprising a folded cavity having a fold mirror, wherein the optical element forms part of the fold mirror of the CO₂ laser.

6. The CO₂ laser of claim 2, wherein the optical element comprises silicon or GaAs.

7. The CO₂ laser of claim 1, wherein the optical element forms part of an output coupler of the CO₂ laser.

8. (canceled)

9. The CO₂ laser of claim 7, wherein the optical element comprises ZnSe, GaAs, Ge or ZnS.

10-15. (canceled)

16. The CO₂ laser of claim 1, wherein the signal comprises a bias voltage.

17. (canceled)

18. The CO₂ laser of claim 1, wherein a reflectivity, a transmissivity and/or an absorptivity of the optical element changes across a range of frequencies of infrared electromagnetic radiation upon receipt of the signal.

19. The CO₂ laser of claim 1, wherein the optical element comprises a switching component operably coupled to the frequency selective structure.

20. The CO₂ laser of claim 19, wherein the optical element comprises a signal transmission component operably coupled to the switching component configured to receive the signal and transmit the signal to the switching component.

21-22. (canceled)

23. The CO₂ laser of claim 1, wherein an electric permittivity and/or a magnetic permeability of the optical element is configured to change upon receipt of the signal.

24. The CO₂ laser of claim 1, wherein a conductivity and a resistivity of the optical element is configured to change upon receipt of the signal.

25. The CO₂ laser of claim 1, wherein the substantially periodic pattern of features comprises an array of geometric features configured to at least partially determine the frequency response of the optical element, wherein the array comprises tuning elements configured to at least partially determine the frequency response of the optical element.

26. (canceled)

27. The CO₂ laser of claim 1, wherein the substantially periodic pattern of features is configured to act as a polarizer.

28. The CO₂ laser of claim 1, wherein the optical element comprises a metamaterial.

29. The CO₂ laser of claim 1, wherein the frequency selective structure comprises a plurality of frequency selective layers configured to at least partially determine the frequency response of the optical element.

30-31. (canceled)

32. The CO₂ laser of claim 1, wherein the signal is configured to:
control a bias level of a switching component of the optical element; and,
control a timing between a laser output command of the CO₂ laser and an initiation of Q-switching of the CO₂ laser.

33-34. (canceled)

35. A laser marking system for marking a target comprising:
a carbon dioxide (CO₂) laser configured to produce infrared electromagnetic radiation comprising,
an optical element comprising a frequency selective structure having a substantially periodic pattern of features, wherein a frequency response of the optical element is configured to change upon receipt of a signal,
wherein a Q-factor of the CO₂ laser changes upon receipt of signal,
wherein the optical element comprises graphene.

36. A method of Q-switching a carbon dioxide (CO₂) laser to produce infrared electromagnetic radiation comprising:
exciting a CO₂ gain medium of the CO₂ laser; and,
generating a signal to change a frequency response of a frequency selective structure having a substantially periodic pattern of features on an optical element of the CO₂ laser and thereby produce a pulse of infrared electromagnetic radiation,
wherein the optical element comprises graphene.

37-38. (canceled)

39. A method of marking a target with infrared electromagnetic radiation comprising:
exciting a carbon dioxide (CO₂) gain medium of the CO₂ laser;
generating a signal to Q-switch the CO₂ laser by changing a frequency response of a frequency selective structure having a substantially periodic pattern of features on an optical element of a CO₂ laser, thereby producing a pulse of infrared electromagnetic radiation; and,
directing the pulse of infrared electromagnetic radiation to the target,
wherein the optical element comprises graphene.

40. (canceled)
